(19) United States
(12) Patent Application Publication
(10) Pub. No.: US 2024/0411200 A1
(43) Pub. Date: Dec. 12, 2024

(54) OPTICAL MODULATOR

(71) Applicant: Murata Manufacturing Co., Ltd., Nagaokakyo-shi (JP)

(72) Inventors: Satoki HAMAMURA, Nagaokakyo-shi (JP); Yasuhiro AIDA, Nagaokakyo-shi (JP)

(21) Appl. No.: 18/804,528

(22) Filed: Aug. 14, 2024

Related U.S. Application Data
(63) Continuation of application No. PCT/JP2023/042864, filed on Nov. 30, 2023.

(30) Foreign Application Priority Data
Mar. 22, 2023 (JP) 2023-045794

(51) Int. Cl. G02F 1/225; G02F 1/21

(52) U.S. Cl. CPC G02F 1/2255; G02F 1/212

(57) ABSTRACT

An optical modulator includes an optical waveguide, first and second electrodes, and a first wiring electrode. The first electrode is on one side of the optical waveguide in a height direction of the optical modulator and extends along a portion of the optical waveguide. The second electrode is on another side of the optical waveguide in the height direction of the optical modulator. The first wiring electrode is on a side of the first electrode opposite to the optical waveguide in the height direction and is electrically connected to the first electrode. The first wiring electrode includes a wiring portion extending from an end portion in an extension direction of the first electrode when viewed along the height direction.

### CROSS REFERENCE TO RELATED APPLICATIONS

This application claims the benefit of priority to Japanese Patent Application No. 2023-045794 filed on Mar. 22, 2023 and is a Continuation Application of PCT Application No. PCT/JP2023/042864 filed on Nov. 30, 2023. The entire contents of each application are hereby incorporated herein by reference.

### BACKGROUND OF THE INVENTION

### 1. Field of the Invention

The present disclosure relates to optical modulators.

### 2. Description of the Related Art

In optical communication, an optical transceiver that converts an optical signal and an electrical signal into each other is required. The optical transceiver includes an optical modulator as a main component. The optical modulator has a role of converting an electrical signal into an optical signal.

For example, FIG. 1 of Japanese Unexamined Patent Application Publication No. 2017-068071 illustrates, as an optical modulator in the related art, an optical modulator having a coplanar electrode arrangement. In this optical modulator, an optical control substrate including an optical waveguide and a control electrode and a circuit substrate including a wiring electrode are laminated. The control electrode is formed on a surface of the optical control substrate on the circuit substrate side to apply an electric field to the optical waveguide in the optical control substrate. The wiring electrode is formed on a surface of the circuit substrate on the optical control substrate side to supply or derive a modulation signal to or from the control electrode. The control electrode includes a signal electrode and a ground electrode. The wiring electrode is provided corresponding to the signal electrode and the ground electrode, and is connected to an end portion of each of the signal electrode and the ground electrode.

In the optical modulator of Japanese Unexamined Patent Application Publication No. 2017-068071, the wiring electrode connected to the signal electrode and the wiring electrode connected to the ground electrode are disposed in parallel on the circuit substrate. These wiring electrodes are not electrodes for applying an electric field to the optical waveguide, and thus are preferably located as far away from each other as possible. When the distance between the wiring electrodes is short, an electric field generated by the wiring electrodes is also applied to a portion of the optical waveguide other than an optical modulation portion, and electrical loss may increase. However, in order to ensure the distance between the wiring electrodes in the optical modulator of Japanese Unexamined Patent Application Publication No. 2017-068071, it is necessary to locate the wiring electrodes as far away from each other in an in-plane direction of the circuit substrate, and there is a problem in that the size of the optical modulator particularly in a width direction increases.

### SUMMARY OF THE INVENTION

Example embodiments of the present invention provide optical modulators that are each able to reduce electrical loss while reducing or preventing an increase in size.

An optical modulator according to an example embodiment of the present invention includes an optical waveguide, a first electrode, a second electrode, and a first wiring electrode. The optical waveguide has an electro-optic effect. The first electrode is on one side of the optical waveguide in a height direction of the optical modulator and extends along a portion of the optical waveguide. The second electrode is on another side of the optical waveguide in the height direction of the optical modulator to generate a potential difference between the second electrode and the first electrode and to apply an electric field to the optical waveguide together with the first electrode. The first wiring electrode is on a side of the first electrode opposite to the optical waveguide in the height direction of the optical modulator and is electrically connected to the first electrode. The first wiring electrode includes a wiring portion extending from an end portion in an extension direction of the first electrode when seen along the height direction of the optical modulator.

According to example embodiments of the present invention, electrical loss is able to be reduced while reducing or preventing an increase in size of the optical modulator.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view illustrating an optical modulator according to a first example embodiment of the present invention.

FIG. 2A is a schematic diagram illustrating a configuration of the optical modulator according to the first example embodiment of the present invention.

FIG. 2B is a schematic diagram illustrating the configuration of the optical modulator according to the first example embodiment of the present invention.

FIG. 2C is a schematic diagram illustrating the configuration of the optical modulator according to the first example embodiment of the present invention.

FIG. 2D is a schematic diagram illustrating the configuration of the optical modulator according to the first example embodiment of the present invention.

FIG. 2E is a schematic diagram illustrating the configuration of the optical modulator according to the first example embodiment of the present invention.

FIG. 2F is a schematic diagram illustrating the configuration of the optical modulator according to the first example embodiment of the present invention.

FIG. 3A is a schematic diagram illustrating an example of a method of manufacturing the optical modulator according to the first example embodiment of the present invention.

FIG. 3B is a schematic diagram illustrating the example of the method of manufacturing the optical modulator according to the first example embodiment of the present invention.

FIG. 3C is a schematic diagram illustrating the example of the method of manufacturing the optical modulator according to the first example embodiment of the present invention.

FIG. 3D is a schematic diagram illustrating the example of the method of manufacturing the optical modulator according to the first example embodiment of the present invention.

FIG. 3E is a schematic diagram illustrating the example of the method of manufacturing the optical modulator according to the first example embodiment of the present invention.

FIG. 4A is a schematic diagram illustrating an example of the method of manufacturing the optical modulator according to the first example embodiment of the present invention.

FIG. 4B is a schematic diagram illustrating the example of the method of manufacturing the optical modulator according to the first example embodiment of the present invention.

FIG. 4C is a schematic diagram illustrating the example of the method of manufacturing the optical modulator according to the first example embodiment of the present invention.

FIG. 4D is a schematic diagram illustrating the example of the method of manufacturing the optical modulator according to the first example embodiment of the present invention.

FIG. 4E is a schematic diagram illustrating the example of the method of manufacturing the optical modulator according to the first example embodiment of the present invention.

FIG. 4F is a schematic diagram illustrating the example of the method of manufacturing the optical modulator according to the first example embodiment of the present invention.

FIG. 4G is a schematic diagram illustrating the example of the method of manufacturing the optical modulator according to the first example embodiment of the present invention.

FIG. 5A is a schematic diagram illustrating an example of the method of manufacturing the optical modulator according to the first example embodiment of the present invention.

FIG. 5B is a schematic diagram illustrating the example of the method of manufacturing the optical modulator according to the first example embodiment of the present invention.

FIG. 5C is a schematic diagram illustrating the example of the method of manufacturing the optical modulator according to the first example embodiment of the present invention.

FIG. 5D is a schematic diagram illustrating the example of the method of manufacturing the optical modulator according to the first example embodiment of the present invention.

FIG. 5E is a schematic diagram illustrating the example of the method of manufacturing the optical modulator according to the first example embodiment of the present invention.

FIG. 5F is a schematic diagram illustrating the example of the method of manufacturing the optical modulator according to the first example embodiment of the present invention.

FIG. 6A is a schematic diagram illustrating an example of the method of manufacturing the optical modulator according to the first example embodiment of the present invention.

FIG. 6B is a schematic diagram illustrating the example of the method of manufacturing the optical modulator according to the first example embodiment of the present invention.

FIG. 6C is a schematic diagram illustrating the example of the method of manufacturing the optical modulator according to the first example embodiment of the present invention.

FIG. 6D is a schematic diagram illustrating the example of the method of manufacturing the optical modulator according to the first example embodiment of the present invention.

FIG. 6E is a schematic diagram illustrating the example of the method of manufacturing the optical modulator according to the first example embodiment of the present invention.

FIG. 6F is a schematic diagram illustrating the example of the method of manufacturing the optical modulator according to the first example embodiment of the present invention.

FIG. 6G is a schematic diagram illustrating the example of the method of manufacturing the optical modulator according to the first example embodiment of the present invention.

FIG. 7 is a schematic diagram illustrating a configuration of an optical modulator according to a second example embodiment of the present invention.

FIG. 8 is a schematic diagram illustrating a configuration of an optical modulator according to a third example embodiment of the present invention.

FIG. 9 is a schematic diagram illustrating the configuration of the optical modulator according to the third example embodiment of the present invention.

FIG. 10 is a plan view illustrating an optical modulator according to a fourth example embodiment of the present invention.

FIG. 11 is a schematic diagram illustrating a configuration of the optical modulator according to the fourth example embodiment of the present invention.

FIG. 12 is a schematic diagram illustrating the configuration of an optical modulator according to a fifth example embodiment of the present invention.

FIG. 13 is a plan view illustrating an optical modulator according to a sixth example embodiment of the present invention.

FIG. 14 is a schematic diagram illustrating a configuration of the optical modulator according to the sixth example embodiment of the present invention.

FIG. 15 is a schematic diagram illustrating a configuration of an optical modulator according to a seventh example embodiment of the present invention.

FIG. 16 is a schematic diagram illustrating a configuration of an optical modulator according to an eighth example embodiment of the present invention.

FIG. 17 is a schematic diagram illustrating a configuration of an optical modulator according to a ninth example embodiment of the present invention.

FIG. 18 is a schematic diagram illustrating a modified example of the optical modulator according to the ninth example embodiment of the present invention.

FIG. 19 is a schematic diagram illustrating a modified example of the optical modulator according to the ninth example embodiment of the present invention.

FIG. 20 is a schematic diagram illustrating a configuration of an optical modulator according to a tenth example embodiment of the present invention.

FIG. 21 is a schematic diagram illustrating a configuration of an optical modulator according to an eleventh example embodiment of the present invention.

FIG. 22 is a schematic diagram illustrating a modified example of the optical modulator according to the eleventh example embodiment of the present invention.

FIG. 23A is a schematic diagram illustrating an example of a method of manufacturing the optical modulator according to the eleventh example embodiment of the present invention.

FIG. 23B is a schematic diagram illustrating the example of the method of manufacturing the optical modulator according to the eleventh example embodiment of the present invention.

FIG. 23C is a schematic diagram illustrating the example of the method of manufacturing the optical modulator according to the eleventh example embodiment of the present invention.

FIG. 23D is a schematic diagram illustrating the example of the method of manufacturing the optical modulator according to the eleventh example embodiment of the present invention.

FIG. 23E is a schematic diagram illustrating the example of the method of manufacturing the optical modulator according to the eleventh example embodiment of the present invention.

FIG. 23F is a schematic diagram illustrating the example of the method of manufacturing the optical modulator according to the eleventh example embodiment of the present invention.

FIG. 24A is a schematic diagram illustrating an example of the method of manufacturing the optical modulator according to the eleventh example embodiment of the present invention.

FIG. 24B is a schematic diagram illustrating the example of the method of manufacturing the optical modulator according to the eleventh example embodiment of the present invention.

FIG. 24C is a schematic diagram illustrating the example of the method of manufacturing the optical modulator according to the eleventh example embodiment of the present invention.

FIG. 24D is a schematic diagram illustrating the example of the method of manufacturing the optical modulator according to the eleventh example embodiment of the present invention.

FIG. 24E is a schematic diagram illustrating the example of the method of manufacturing the optical modulator according to the eleventh example embodiment of the present invention.

FIG. 24F is a schematic diagram illustrating the example of the method of manufacturing the optical modulator according to the eleventh example embodiment of the present invention.

FIG. 25A is a schematic diagram illustrating an example of the method of manufacturing the optical modulator according to the eleventh example embodiment of the present invention.

FIG. 25B is a schematic diagram illustrating the example of the method of manufacturing the optical modulator according to the eleventh example embodiment of the present invention.

FIG. 25C is a schematic diagram illustrating the example of the method of manufacturing the optical modulator according to the eleventh example embodiment of the present invention.

FIG. 25D is a schematic diagram illustrating the example of the method of manufacturing the optical modulator according to the eleventh example embodiment of the present invention.

FIG. 25E is a schematic diagram illustrating the example of the method of manufacturing the optical modulator according to the eleventh example embodiment of the present invention.

FIG. 26 is a schematic diagram illustrating a configuration of an optical modulator according to a twelfth example embodiment of the present invention.

FIG. 27 is a schematic diagram illustrating a configuration of an optical modulator according to a thirteenth example embodiment of the present invention.

FIG. 28 is a schematic diagram illustrating a configuration of an optical modulator according to a fourteenth example embodiment of the present invention.

FIG. 29 is a schematic diagram illustrating a configuration of an optical modulator according to a fifteenth example embodiment of the present invention.

FIG. 30 is a schematic diagram illustrating a configuration of the optical modulator according to the fifteenth example embodiment of the present invention.

FIG. 31 is a schematic diagram illustrating the configuration of the optical modulator according to the fifteenth example embodiment of the present invention.

FIG. 32 is a schematic diagram illustrating the configuration of the optical modulator according to the fifteenth example embodiment of the present invention.

### DETAILED DESCRIPTION OF THE EXAMPLE EMBODIMENTS

Hereinafter, example embodiments of the present invention will be described with reference to the drawings. In the following description, the example embodiments of the present invention will be described using examples, but the present invention is not limited to the examples described below. In the following description, a specific numerical value or a specific material will be used as an example, but the present invention is not limited to this example.

An optical modulator according to an example embodiment of the present invention includes an optical waveguide, a first electrode, a second electrode, and a first wiring electrode. The optical waveguide has an electro-optic effect. The first electrode is disposed on one side of the optical waveguide in a height direction of the optical modulator and extends along a portion of the optical waveguide. The second electrode is disposed on another side of the optical waveguide in the height direction of the optical modulator, forms a potential difference between the second electrode and the first electrode, and applies an electric field to the optical waveguide together with the first electrode. The first wiring electrode is disposed on a side of the first electrode opposite to the optical waveguide in the height direction of the optical modulator and is electrically connected to the first electrode. The first wiring electrode includes a wiring portion that extends from an end portion in an extension direction of the first electrode when seen along the height direction of the optical modulator (first configuration).

In an example embodiment of the present invention, the first electrode is disposed on one side of the optical waveguide in the height direction of the optical modulator. The first wiring electrode that is electrically connected to the first electrode and supplies an electrical signal to the first electrode or extracts an electrical signal from the first electrode includes a wiring portion extending from an end portion of the first electrode when seen along the height direction of the optical modulator, and is disposed on a side of the first electrode opposite to the optical waveguide in the height direction of the optical modulator. On the other hand, the second electrode to apply an electric field to the optical waveguide together with the first electrode together is disposed on the side opposite to the first electrode and the first wiring electrode in the height direction of the optical modulator. Therefore, a wiring electrode to supply an electrical signal to the second electrode or extract an electrical signal from the second electrode naturally becomes spaced away from the wiring portion of the first wiring electrode in the height direction of the optical modulator. As a result, an electric field is not likely to be generated between the wiring electrodes, and an excess electric field can be prevented from being applied to a portion of the optical waveguide other than the optical modulation portion. Accordingly, with the first configuration, electrical loss can be reduced while reducing or preventing an increase in size of the optical modulator, in particular, an increase in size in a width direction.

In an optical modulator according to an example embodiment of the present invention, for example, the first electrode is disposed in a cavity provided in the optical modulator (second configuration). In this case, the first electrode can be relatively freely disposed using the cavity.

In an optical modulator according to an example embodiment of the present invention, it is preferable that the first wiring electrode is disposed in the cavity and is supported by a side wall defining the cavity (third configuration).

In an example embodiment of the present invention, the first wiring electrode is supported by the side wall defining the cavity. Therefore, buckling of the first wiring electrode can be reduced or prevented. For example, even when the first wiring electrode is formed in a state where an internal stress is generated such that the first wiring electrode cannot endure the internal stress during use of the optical modulator, buckling of the first wiring electrode is not likely to occur. Therefore, deformation of the optical modulator can be reduced or prevented.

In an optical modulator according example embodiment of the present invention, the first wiring electrode may be spaced away from the first electrode in the height direction and may include a main body portion including a portion of which defines the wiring portion and a connection portion that connects the main body portion and the first electrode. The connection portion can be inclined with respect to the height direction when seen in a cross-section perpendicular or substantially perpendicular to the extension direction of the first electrode (fourth configuration).

For example, when the connection portion that connects the first electrode and the main body portion of the first wiring electrode is parallel or substantially parallel to the height direction of the optical modulator when seen in a cross-section perpendicular or substantially perpendicular to the extension direction of the first electrode, a right-angled corner portion is provided in a coupling portion between the first electrode and the first wiring electrode, and loss of a high frequency signal occurs in the corner portion. However, in an example embodiment of the present invention, the connection portion of the first wiring electrode is inclined with respect to the height direction of the optical modulator when seen in the cross-section perpendicular or substantially perpendicular to the extension direction of the first electrode. Therefore, the first wiring electrode can be coupled to the first electrode at a gentle angle. As a result, loss of a high frequency signal in the coupling portion between the first electrode and the first wiring electrode can be reduced, and modulation in a broad band can be achieved.

In an optical modulator according to an example embodiment of the present invention, the first wiring electrode may be spaced away from the first electrode in the height direction and may include a main body portion including a portion of which defines the wiring portion and a connection portion that connects the main body portion and the first electrode. The connection portion can include a surface that is continuous to the end portion in the extension direction of the first electrode, and the surface can be inclined with respect to the height direction such that the main body portion side with respect to the first electrode side becomes spaced away from the first electrode in the extension direction when seen along a width direction of the optical modulator.

For example, in the connection portion that connects the first electrode and the main body portion of the first wiring electrode, in a case where the surface that is continuous to the end portion in the extension direction of the first electrode is parallel or substantially parallel to the height direction of the optical modulator when seen along the width direction of the optical modulator, a right-angled corner portion is provided between this surface and the end portion of the first electrode, and loss of a high frequency signal occurs in this corner portion. However, in an example embodiment of the present invention, the surface of the connection portion of the first wiring electrode is inclined with respect to the height direction of the optical modulator such that the main body portion side with respect to the first electrode side becomes spaced away from the first electrode in the extension direction when seen along a width direction of the optical modulator. Therefore, the surface of the connection portion of the first wiring electrode can be made continuous to the first electrode at a gentle angle. As a result, loss of a high frequency signal at a boundary between the surface of the connection portion and the first electrode can be reduced, and modulation in a broad band can be achieved.

In an optical modulator according to an example embodiment of the present invention, at least a portion of the first wiring electrode may be self-supporting and disposed in the cavity (sixth configuration).

For example, in the optical modulator, when the first wiring electrode is provided on a surface that is roughened by processing, peeling of the first wiring electrode is likely to occur, and the surface roughness may lead to loss of an electrical signal. On the other hand, in an example embodiment of the present invention, at least a portion of the first wiring electrode is self-supporting in the cavity. In this case, peeling of the first wiring electrode does not occur, and loss of an electrical signal caused by surface roughness can be prevented.

An optical modulator according to an example embodiment of the present invention may further include a through-electrode that is connected to the wiring portion of the first wiring electrode and extends from the first electrode side toward the second electrode side (seventh configuration).

In an example embodiment of the present invention, the through-electrode that extends from the first electrode side toward the second electrode side is provided. The through-electrode is connected to the wiring portion of the first wiring electrode. In this case, an electrical signal of the first electrode is extracted to the second electrode side through the wiring portion of the first wiring electrode and the through-electrode. Therefore, an electrode pad for the first electrode can be disposed on the same plane as an electrode pad for the second electrode, and electrode wirings can be simplified. In addition, the electrode wirings for the first electrode and the electrode wirings for the second electrode can be located close to each other, and loss of an electrical signal can be reduced.

In an optical modulator according to an example embodiment of the present invention, it is preferable that the through-electrode is inclined with respect to the height direction of the optical modulator (eighth configuration).

For example, when the through-electrode is disposed parallel or substantially parallel to the height direction of the optical modulator, a right-angled corner portion is provided in a coupling portion between the through-electrode and the first wiring electrode, and loss of a high frequency signal occurs in this corner portion. However, in an example embodiment of the present invention, the through-electrode is inclined with respect to the height direction of the optical modulator. Therefore, the through-electrode and the first wiring electrode can be gently coupled to each other. As a result, loss of a high frequency signal in the coupling portion between the through-electrode and the first wiring electrode can be reduced, and modulation in a broad band can be achieved.

In an optical modulator according to an example embodiment of the present invention, it is preferable that a thickness of the first electrode is greater than a thickness of the first wiring electrode.

The first electrode is an electrode to apply an electric field to the optical waveguide together with the second electrode to modulate an optical signal. In an example embodiment of the present invention, the thickness of the first electrode is greater than the thickness of the first wiring electrode. As a result, a resistance of the first electrode in a portion of the optical modulator where optical modulation is performed can be reduced, and thus loss of an electrical signal can be reduced.

In an optical modulator according to an example embodiment of the present invention, the first electrode and the first wiring electrode may be coupled and a void may be provided at an interface between the first electrode and the first wiring electrode.

In an example embodiment of the present invention, the void is provided at the interface between the first electrode and the first wiring electrode. Due to this void, a capacitance can be added, and characteristic impedance can be adjusted. In addition, the void has a lower dielectric constant than an electro-optic material. Therefore, an effective refractive index of an electrical signal can be reduced, and loss of an electrical signal in the first electrode and the first wiring electrode can be reduced.

In an optical modulator according to an example embodiment of the present invention, the first electrode and the first wiring electrode may be coupled and oxygen may be provided at an interface between the first electrode and the first wiring electrode.

In an example embodiment of the present invention, oxygen is provided at the interface between the first electrode and the first wiring electrode. Due to the oxygen, a capacitance can be added, and characteristic impedance can be adjusted. In addition, when oxygen is coupled with a metal, the dielectric constant thereof is lower than that of an electro-optic material. Therefore, an effective refractive index of an electrical signal can be reduced, and loss of an electrical signal in the first electrode and the first wiring electrode can be reduced.

In an optical modulator according to an example embodiment of the present invention, the first electrode and the first wiring electrode may be coupled and a eutectic may be provided between the first electrode and the first wiring electrode.

In an example embodiment of the present invention, the eutectic is provided between the first electrode and the first wiring electrode. Therefore, a coupling strength between the first electrode and the first wiring electrode can be increased. In addition, loss of electrical connection between the first electrode and the first wiring electrode can be reduced.

In an optical modulator according to an example embodiment of the present invention, the first electrode and the first wiring electrode may be coupled and a resin may be provided at an interface between the first electrode and the first wiring electrode.

In an example embodiment of the present invention, the resin is provided at the interface between the first electrode and the first wiring electrode. Due to this resin, a capacitance can be added, and characteristic impedance can be adjusted. In addition, the resin has a lower dielectric constant than an electro-optic material. Therefore, an effective refractive index of an electrical signal can be reduced, and loss of an electrical signal in the first electrode and the first wiring electrode can be reduced.

In an optical modulator according to an example embodiment of the present invention, it is preferable that, in a width direction of the optical modulator, a length of the first electrode is greater than a length of the optical waveguide.

In an example embodiment of the present invention, the width of the first electrode (the length in the width direction of the optical modulator) is greater than the width of the optical waveguide (the length in the width direction of the optical modulator). Therefore, a uniform electric field can be applied from the first electrode to the optical waveguide. As a result, the integrity of an optical signal generated by the optical modulator can be improved.

It is preferable that an optical modulator according to an example embodiment of the present invention further includes a low dielectric constant layer that is provided at at least one of a position between the optical waveguide and the first electrode and a position between the optical waveguide and the second electrode and has a refractive index lower than a refractive index of the optical waveguide.

In an example embodiment of the present invention, the low dielectric constant layer is provided between the optical waveguide and the first electrode and/or the second electrode. Therefore, light from the optical waveguide is not likely to be absorbed by the first electrode and/or the second electrode, and loss of the light can be reduced or prevented. In addition, by providing the low dielectric constant layer, the effective refractive index of a high frequency signal can be adjusted to match with the effective refractive index of a light wave. Therefore, optical modulation can be performed up to a higher frequency. Further, by providing the low dielectric constant layer, the effective dielectric constant to an electrical signal can be reduced. Therefore, loss of a high frequency signal can be reduced or prevented, and optical modulation can be performed up to a higher frequency.

In an optical modulator according to an example embodiment of the present invention, it is preferable that, when the low dielectric constant layer is provided in a range from the optical waveguide to the first electrode and a range from the optical waveguide to the first wiring electrode in the height direction, a length in the height direction of the low dielectric constant layer in the range from the optical waveguide to the first wiring electrode is greater than a length in the height direction of the low dielectric constant layer in the range from the optical waveguide to the first electrode.

It is preferable that an optical modulator according to an example embodiment of the present invention further includes a support substrate that is disposed on the side of the first electrode opposite to the optical waveguide and is made of a low dielectric constant material having a refractive index lower than a refractive index of the optical waveguide.

In an example embodiment of the present invention, the support substrate made of the low dielectric constant material is provided on the side of the first electrode opposite to the optical waveguide. In addition, the effective refractive index of a high frequency signal can be adjusted to match with the effective refractive index of a light wave. Therefore, optical modulation in a broader band can be performed. Further, by providing the support substrate made of the low dielectric constant material, the effective dielectric constant to an electrical signal can be reduced. Therefore, loss of a high frequency signal can be reduced or prevented, and optical modulation can be performed up to a higher frequency.

An optical modulator according to a an example embodiment of the present invention can further include a second wiring electrode that is disposed on a side of the second electrode opposite to the optical waveguide in the height direction of the optical modulator and is electrically connected to the second electrode.

An optical modulator according to an example embodiment of the present invention may further include a through-electrode that is connected to the second wiring electrode and extends from the second electrode side toward the first electrode side.

In an optical modulator according to an example embodiment of the present invention, it is preferable that a thickness of the second electrode is greater than a thickness of the second wiring electrode.

An optical modulator according to an example embodiment of the present invention can further include a first low dielectric constant layer that is provided in a range from the optical waveguide to the first electrode and a range from the optical waveguide to the first wiring electrode in the height direction and has a refractive index lower than a refractive index of the optical waveguide, and a second low dielectric constant layer that is provided in a range from the optical waveguide to the second electrode and a range from the optical waveguide to the second wiring electrode in the height direction and has a refractive index lower than a refractive index of the optical waveguide. In this case, it is preferable that a length in the height direction of the first low dielectric constant layer in the range from the optical waveguide to the first wiring electrode is greater than a length in the height direction of the first low dielectric constant layer in the range from the optical waveguide to the first electrode, and it is preferable that a length in the height direction of the second low dielectric constant layer in the range from the optical waveguide to the second wiring electrode is greater than a length in the height direction of the second low dielectric constant layer in the range from the optical waveguide to the second electrode.

Hereinafter, example embodiments of the present disclosure will be described with reference to the drawings. In the drawings, the same or equivalent elements and configurations are represented by the same reference numerals, and repeated description will not be repeated.

### First Example Embodiment

### Configuration of Optical Modulator

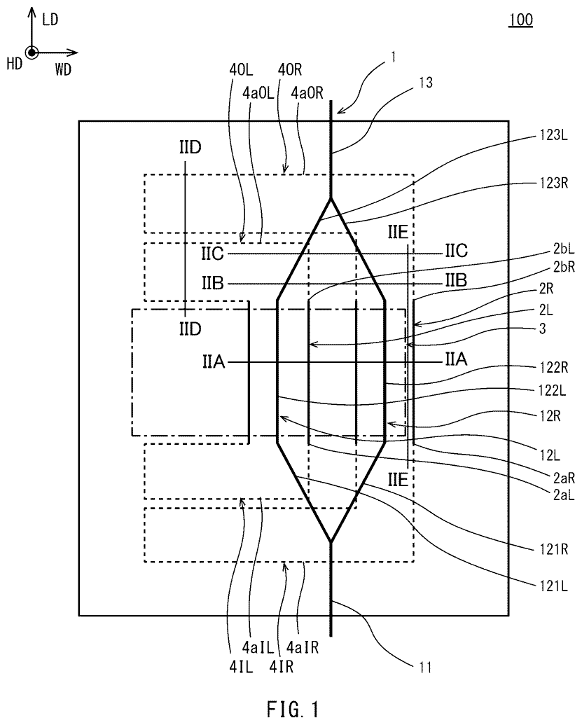

FIG. 1 is a plan view illustrating an optical modulator 100 according to a first example embodiment of the present invention. Referring to FIG. 1, in the example of the present example embodiment, the optical modulator 100 is, for example, a Mach-Zehnder type optical modulator. The optical modulator 100 includes an optical waveguide 1, first electrodes 2R and 2L, a second electrode 3, and first wiring electrodes 4IR, 4IL, 4OR, and 4OL. FIG. 1 illustrates the optical waveguide 1, the first electrodes 2R and 2L, the second electrode 3, and the first wiring electrodes 4IR, 4IL, 4OR, and 4OL when projected to a plane perpendicular or substantially perpendicular to a height direction HD of the optical modulator 100. In FIG. 1, the second electrode 3 is indicated by a dot-dashed line, and the first wiring electrodes 4IR, 4IL, 4OR, and 4OL are indicated by a broken line. In the present specification, the height direction HD refers to a lamination direction of the elements in the optical modulator 100 having a laminated structure. A direction in which the optical waveguide 1 extends or substantially extends and that is perpendicular or substantially perpendicular to the height direction HD is defined as a longitudinal direction LD of the optical modulator 100. A direction perpendicular or substantially perpendicular to the height direction HD and the longitudinal direction LD is a width direction WD of the optical modulator 100.

The optical waveguide 1 defines and functions as an optical transmission line. The optical waveguide 1 includes an input optical waveguide 11 that is a light input side, two branched optical waveguides 12R and 12L branched from the input optical waveguide 11, and an output optical waveguide 13 that is a light output side where the two branched optical waveguides 12R and 12L are combined. The input optical waveguide 11 and the output optical waveguide 13 extend linearly, for example, along the longitudinal direction LD. The branched optical waveguides 12R and 12L include input relay portions 121R and 121L, linear portions 122R and 122L, and output relay portions 123R and 123L. The linear portions 122R and 122L are disposed in parallel or substantially in parallel in the width direction WD. The linear portions 122R and 122L are connected to the input optical waveguide 11 through the input relay portions 121R and 121L. The linear portions 122R and 122L are connected to the output optical waveguide 13 through the output relay portions 123R and 123L.

The first electrodes 2R and 2L extend along a portion of the optical waveguide 1. More specifically, the first electrodes 2R and 2L extend along the linear portions 122R and 122L in the branched optical waveguides 12R and 12L, respectively. For example, when seen along the height direction HD, the first electrodes 2R and 2L are disposed to overlap the linear portions 122R and 122L of the branched optical waveguides 12R and 12L, respectively.

When seen along the height direction HD, the second electrode 3 is disposed such that at least a portion thereof overlaps the optical waveguide 1 and the first electrodes 2R and 2L. For example, when seen along the height direction HD, the second electrode 3 overlaps the linear portions 122R and 122L of the branched optical waveguides 12R and 12L.

The second electrode 3 generates a potential difference between the second electrode 3 and each of the first electrodes 2R and 2L, and applies an electric field to the optical waveguide 1 together with the first electrodes 2R and 2L. The first electrodes 2R and 2L and the second electrode 3 define and function as, for example, control electrodes to control light transmitted through the optical waveguide 1. The first electrode 2R and the second electrode 3 are disposed such that an electric field can be applied to the branched optical waveguide 12R. The first electrode 2L and the second electrode 3 are disposed such that an electric field can be applied to the branched optical waveguide 12L. The linear portions 122R and 122L are substantially the optical modulation portions of the optical waveguide 1. For example, the first electrodes 2R and 2L can define and function as signal electrodes, and the second electrode 3 can define and function as a ground electrode. Alternatively, the first electrodes 2R and 2L can define and function as ground electrodes, and the second electrode 3 can define and function as a signal electrode.

The first wiring electrodes 4IR, 4IL, 4OR, and 4OL are disposed on the optical modulator 100 to supply an electrical signal to the first electrodes 2R and 2L or extract an electrical signal from the first electrodes 2R and 2L. The first wiring electrodes 4IR and 4OR are electrically connected to the first electrode 2R. The first wiring electrodes 4IL and 4OL are electrically connected to the first electrode 2L. The first wiring electrodes 4IR and 4IL are disposed on the input side of the first electrodes 2R and 2L, and the first wiring electrodes 4OR and 4OL are disposed on the output side of the first electrodes 2R and 2L. In the example of the present example embodiment, the first wiring electrodes 4IL and 4OL protrude from the first electrode 2L in the width direction WD when seen along the height direction HD. Specifically, the first wiring electrode 4IL includes a wiring portion 4aIL. When seen along the height direction HD, the wiring portion 4aIL extends from one end portion 2aL in an extension direction of the first electrode 2L. The first wiring electrode 4OL includes a wiring portion 4aOL. When seen along the height direction HD, the wiring portion 4aOL extends from another end portion 2bL in the extension direction of the first electrode 2L. The first wiring electrodes 4IR and 4OR protrude from the first electrode 2R in the width direction WD when seen along the height direction HD. Specifically, the first wiring electrode 4IR includes a wiring portion 4aIR. When seen along the height direction HD, the wiring portion 4aIR extends from one end portion 2aR in an extension direction of the first electrode 2R. The first wiring electrode 4OR includes a wiring portion 4aOR. When seen along the height direction HD, the wiring portion 4aOR extends from another end portion 2bR in the extension direction of the first electrode 2R.

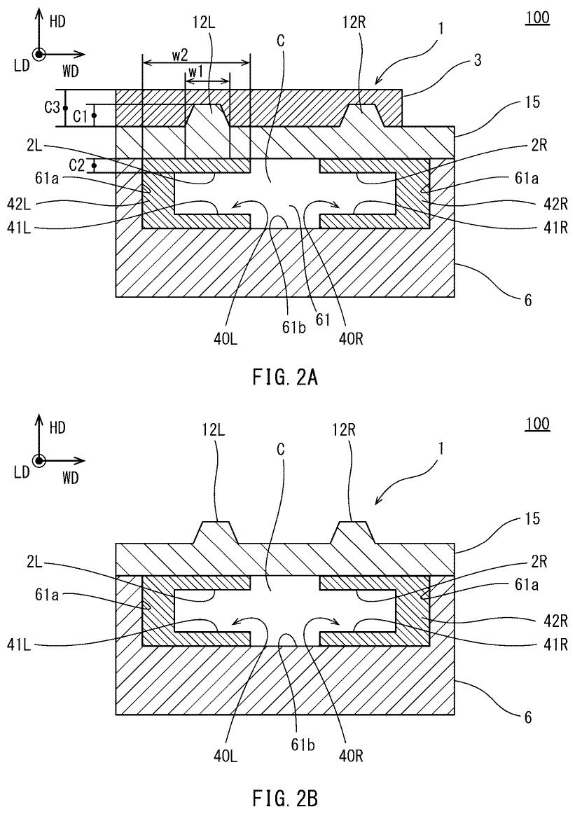

Next, a more specific configuration of the optical modulator 100 illustrated in FIG. 1 will be described with reference to FIGS. 2A to 2F. FIG. 2A is a cross-sectional view taken along line IIA-IIA of FIG. 1. In other words, FIG. 2A is a cross-sectional view when the optical modulator 100 is cut along a surface perpendicular or substantially perpendicular to the longitudinal direction LD at positions of the linear portions 122R and 122L of the branched optical waveguides 12R and 12L (the optical modulation portions of the optical waveguide 1).

Referring to FIG. 2A, the optical waveguide 1 has an electro-optic effect. In the example of the present example embodiment, the optical waveguide 1 is provided on a base layer 15. In the example of the present example embodiment, the optical waveguide 1 protrudes from a surface of the base layer 15. That is, for example, the optical waveguide 1 is a ridge type optical waveguide. The optical waveguide 1 does not need to be a ridge type optical waveguide. The optical waveguide 1 may have a trapezoidal or substantially trapezoidal cross-sectional shape as illustrated in FIG. 2A, but may also have a different cross-sectional shape such as a rectangular or substantially rectangular shape, for example.

The optical waveguide 1 is made of an electro-optic material. As the electro-optic material, for example, LiNbO₃ (lithium niobate), LiTaO₃ (lithium tantalate), PLZT (lead lanthanum zirconate titanate), KTN (potassium niobate tantalate), BaTiO₃ (barium titanate), or the like may be used. As the electro-optic material, for example, an electro-optic polymer (EO polymer) may be used. The base layer 15 may be made of an electro-optic material as in the optical waveguide 1. The base layer 15 does not need to be provided in the optical modulator 100.

The first electrodes 2R and 2L are disposed on one side of the optical waveguide 1 in the height direction HD of the optical modulator 100. That is, a center C2 of the first electrodes 2R and 2L in the height direction HD is positioned on one side in the height direction HD from a center C1 of the optical waveguide 1 (branched optical waveguides 12R and 12L) in the height direction HD of the optical modulator 100. In the example of the present example embodiment, all of the first electrodes 2R and 2L are disposed on one side of the optical waveguide 1 in the height direction HD. The first electrode 2R is laminated on one side of the branched optical waveguide 12R in the height direction HD. The first electrode 2L is laminated on one side of the branched optical waveguide 12L in the height direction HD. In the present example embodiment, the first electrodes 2R and 2L have a rectangular or substantially rectangular cross-sectional shape. The cross-sectional shape of the first electrodes 2R and 2L is not limited to this example.

A width w2 of the first electrodes 2R and 2L is preferably greater than a width w1 of the optical waveguide 1. However, the width w2 of the first electrodes 2R and 2L may be less than or equal to the width w1 of the optical waveguide 1. The width w2 of the first electrodes 2R and 2L is the maximum dimension of the first electrodes 2R and 2L in the width direction WD. The width w1 of the optical waveguide 1 is the maximum dimension in the width direction WD of portions of the optical waveguide 1 corresponding to the first electrodes 2R and 2L, respectively. In the present example embodiment, the width w1 is the maximum dimension in the width direction WD of each of the branched optical waveguides 12R and 12L.

The first wiring electrodes 4OR and 4OL are disposed on sides of the first electrodes 2R and 2L opposite to the optical waveguide 1 in the height direction HD. The first wiring electrode 4OR includes a main body portion 41R and a connection portion 42R. The first wiring electrode 4OL includes a main body portion 41L and a connection portion 42L.

The main body portion 41R is spaced away from the first electrode 2R in the height direction HD. The main body portion 41L is spaced away from the first electrode 2L in the height direction HD. The main body portions 41R and 41L are disposed, for example, immediately below the first electrodes 2R and 2L in a cross-sectional view of the optical modulator 100. The main body portions 41R and 41L face the first electrodes 2R and 2L with gaps in the height direction HD, respectively. The connection portion 42R connects the main body portion 41R and the first electrode 2R to each other. The connection portion 42L connects the main body portion 41L and the first electrode 2L to each other. The connection portion 42R may connect outer side end portions in the width direction WD of the main body portion 41R and the first electrode 2R to each other. Similarly, the connection portion 42L may connect outer side end portions in the width direction WD of the main body portion 41L and the first electrode 2L to each other. The connection portions 42R and 42L extend from the main body portions 41R and 41L toward the first electrodes 2R and 2L in a cross-sectional view of the optical modulator 100.

In the present example embodiment, the main body portions 41R and 41L and the connection portions 42R and 42L may have a rectangular or substantially rectangular cross-sectional shape. The cross-sectional shape of the first electrodes 2R and 2L is not limited to this example.

The optical modulator 100 can further include a support substrate 6. The support substrate 6 supports the optical waveguide 1, the first electrodes 2R and 2L, the second electrode 3, and the first wiring electrodes 4OR and 4OL. As the support substrate 6, for example, a semiconductor material can be used. As the semiconductor material, for example, a single-element semiconductor such as Si (silicon) or Ge (germanium) or a compound semiconductor such as GaAs (gallium arsenide) is used. As the support substrate 6, an oxide such as SiO₂, Al₂O₃, LaAlO₃, LaYO₃, ZnO, HfO₂, MgO, or Y₂O₃ may be used. Alternatively, as the support substrate 6, an electro-optic material, specifically, for example, LiNbO₃, LiTaO₃, PLZT, KTN, or BaTiO₃ may be used.

In the example of the present example embodiment, a cavity C is provided in the optical modulator 100. The cavity C is provided between the support substrate 6 and the optical waveguide 1. In the present example embodiment, the cavity C is a closed space in a cross-sectional view of the optical modulator 100. The cavity C can be provided, for example, with a recess portion 61 provided in the support substrate 6 and the base layer 15. Specifically, the cavity C is defined by side walls 61a and 61a and a bottom wall 61b of the recess portion 61 and the base layer 15. The first electrodes 2R and 2L and the first wiring electrodes 4OR and 4OL are disposed in the cavity C. The first wiring electrodes 4OR and 4OL are supported by the side walls 61a and 61a. More specifically, the connection portion 42R of the first wiring electrode 4OR is provided along one side wall 61a, and the connection portion 42L of the first wiring electrode 4OL is provided along the other side wall 61a. In addition, the main body portions 41R and 41L of the first wiring electrodes 4OR and 4OL are provided along the bottom wall 61b.

The second electrode 3 is disposed on another side of the optical waveguide 1 (opposite to the first electrodes 2R and 2L) in the height direction HD of the optical modulator 100. That is, a center C3 of the second electrode 3 in the height direction HD of the optical modulator 100 is positioned on another side in the height direction HD from the center C1 of the optical waveguide 1. In the example of the present example embodiment, the second electrode 3 is laminated on the side of the optical waveguide 1 opposite to the first electrodes 2R and 2L in the height direction HD. More specifically, the second electrode 3 is laminated on the side of each of the branched optical waveguides 12R and 12L opposite to the first electrodes 2R and 2L. The second electrode 3 is disposed on the sides of the branched optical waveguides 12R and 12L opposite to the first electrodes 2R and 2L such that the branched optical waveguides 12R and 12L are positioned between the first electrodes 2R and 2L.

In the example of the present example embodiment, the second electrode 3 is shared by the two branched optical waveguides 12R and 12L. The second electrode 3 may be provided on each of the branched optical waveguides 12R and 12L.

FIGS. 2B and 2C are cross-sectional views taken alone line IIB-IIB and line IIC-IIC of FIG. 1, respectively. FIG. 2B is a cross-sectional view when the optical modulator 100 is cut along the surface perpendicular or substantially perpendicular to the longitudinal direction LD at positions of the output relay portions 123R and 123L of the branched optical waveguides 12R and 12L. FIG. 2C is a cross-sectional view when the optical modulator 100 is cut along the surface perpendicular or substantially perpendicular to the longitudinal direction LD at positions closer to the output optical waveguide 13 than the cross-section illustrated in FIG. 2B in the output relay portions 123R and 123L of the branched optical waveguides 12R and 12L.

Referring to FIG. 2B, the second electrode 3 is not present at a position of the optical waveguide 1 on the output side further than the optical modulation portion. Referring to FIG. 2C, at a position closer to the output side, not only the second electrode 3 but also the connection portions 42R and 42L of the first electrodes 2R and 2L and the first wiring electrodes 4OR and 4OL are not present. Therefore, an electric field generated by the first electrodes 2R and 2L and the second electrode 3 is not substantially applied to a portion of the optical waveguide 1 other than the optical modulation portion. In addition, the main body portions 41R and 41L of the first wiring electrodes 4OR and 4OL are spaced away from the optical waveguide 1 in the height direction HD. Therefore, in the portion of the optical waveguide 1 other than the optical modulation portion, the effect of the electric field on the first wiring electrodes 4OR and 4OL does not also substantially occur. At this position, the main body portions 41R and 41L of the first wiring electrodes 4OR and 4OL are portions extending from the first electrodes 2R and 2L when seen along the height direction HD, and define the wiring portion 4aOL.

FIG. 2D is a cross-sectional view taken along line IID-IID of FIG. 1. In other words, FIG. 2D is a cross-sectional view when the first wiring electrodes 4OR and 4OL extends from the first electrodes 2R and 2L in the width direction WD are cut along a surface perpendicular or substantially perpendicular to the width direction WD.

Referring to FIG. 2D, in the cross-section of the portions of the first wiring electrodes 4OR and 4OL extending from the first electrodes 2R and 2L in the width direction WD, the first electrodes 2R and 2L, the second electrode 3, and the connection portions 42R and 42L of the first wiring electrodes 4OR and 4OL are not present, and the main body portions 41R and 41L of the first wiring electrodes 4OR and 4OL are present. At this position, the main body portions 41R and 41L of the first wiring electrodes 4OR and 4OL are portions extending from the first electrodes 2R and 2L when seen along the height direction HD, and define the wiring portion 4aOL.

FIG. 2E is a cross-sectional view taken along line IIE-IIE of FIG. 1. In other words, FIG. 2E is a cross-sectional view when the optical modulator 100 is cut along a surface perpendicular or substantially perpendicular to the width direction WD, and is a diagram illustrating the first electrode 2R and the first wiring electrode 4OR when seen along the width direction WD. FIG. 2E also illustrates line IIA-IIA, line IIB-IIB, and line IIC-IIC of FIG. 1.

Referring to FIG. 2E, the connection portion 42R of the first wiring electrode 4OR includes a surface 42a that is continuous to the end portion in the extension direction (longitudinal direction LD) of the first electrode 2R. The surface 42a is inclined with respect to the height direction HD such that the main body portion 41R side of the first wiring electrode 4OR with respect to the first electrode 2R side becomes spaced away from the first electrode 2R in the extension direction when seen along the width direction WD. When seen along the width direction WD, the surface 42a of the connection portion 42R may be linear or may be curved.

Although not illustrated in FIG. 2E, the connection portion 42L of the first wiring electrode 4OL can have the same or substantially the same configuration as the connection portion 42R of the first wiring electrode 4OR. That is, the surface of the connection portion 42L that is continuous to the end portion in the extension direction of the first electrode 2L may be inclined with respect to the height direction HD such that the main body portion 41L side of the first wiring electrode 4OL with respect to the first electrode 2L side becomes spaced away from the first electrode 2L.

FIG. 2F is a partially enlarged cross-sectional view illustrating the first electrode 2L and the first wiring electrode 4OL. Referring to FIG. 2F, the first electrode 2L and the first wiring electrode 4OL are coupled. More specifically, the first electrode 2L is coupled to the connection portion 42L of the first wiring electrode 4OL. When the first electrode 2L and the first wiring electrode 4OL are coupled, a fine void V may be provided at an interface between the first electrode 2L and the first wiring electrode 4OL. In addition, oxygen may be provided at the interface between the first electrode 2L and the first wiring electrode 4OL. The oxygen is, for example, oxygen of an oxide. In this case, the oxygen provided at the interface between the first electrode 2L and the first wiring electrode 4OL is higher than that in the first electrode 2L and that in the first wiring electrode 4OL by, for example, about 1 mass % or more. In addition, a eutectic may be provided between the first electrode 2L and the first wiring electrode 4OL. The eutectic is produced when the first electrode 2L and the first wiring electrode 4OL are coupled using a eutectic reaction of metal. In addition, a resin may be provided at the interface between the first electrode 2L and the first wiring electrode 4OL. This resin is, for example, a conductive resin. When any one of the void, the oxygen, the eutectic, or the resin is provided between the first electrode 2L and the connection portion 42L, electrical connection between the first electrode 2L and the connection portion 42L is ensured.

Although not illustrated in FIG. 2F, a void, oxygen, or a resin may also be provided at an interface between the first electrode 2R and the first wiring electrode 4OR. Alternatively, a eutectic may be provided between the first electrode 2R and the first wiring electrode 4OR.

FIGS. 2A to 2F mainly illustrate a configuration of the output side of the optical modulator 100. The configuration of the input side of the optical modulator 100 can have the same or substantially the same configuration as the output side thereof. Therefore, the description of the specific configuration of the input side will not be made.

### Method of Manufacturing Optical Modulator 100

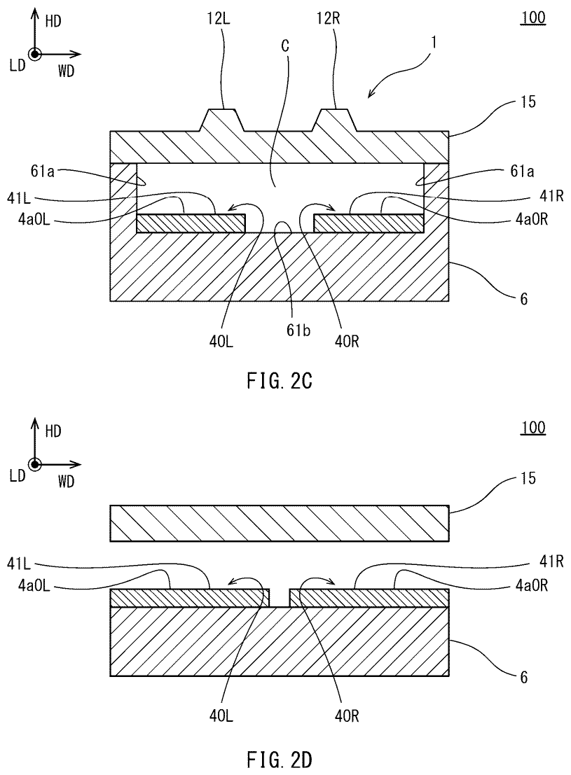

Hereinafter, an example of a method of manufacturing the optical modulator 100 will be described. FIGS. 3A to 3E are schematic diagrams illustrating an example of the method of manufacturing the optical modulator 100. As illustrated in FIG. 3A, the support substrate 6 and an electro-optic material substrate 16 are prepared.

Next, as illustrated in FIG. 3B, the recess portion 61 is formed in the support substrate 6 by, for example, dry etching, wet etching, cutting with a dicing machine, or the like. The recess portion 61 forms the cavity C. On the other hand, by patterning the electro-optic material substrate 16 by, for example, lithography or the like, the base layer 15 including the optical waveguide 1 is formed by, for example, dry etching, wet etching, cutting with a dicing machine, or the like.

Next, as illustrated in FIG. 3C, by forming electrodes on the support substrate 6 where the recess portion 61 is formed and patterning the electrodes by lithography or the like, the first wiring electrodes 4OR and 4OL are formed in the recess portion 61. On the other hand, by forming electrodes on the base layer 15 including the optical waveguide 1 and patterning the electrodes by lithography or the like, the first electrodes 2R and 2L are formed on the surface of the base layer 15.

Next, as illustrated in FIG. 3D, the first electrodes 2R and 2L of the base layer 15 are adhered to the first wiring electrodes 4OR and 4OL of the support substrate 6. The components are adhered by, for example, bonding using metal, bonding using a conductive resin, or the like.

As illustrated in FIG. 3E, the second electrode 3 is formed on the base layer 15 including the optical waveguide 1 by, for example, sputtering, vapor deposition, epitaxial growth, or the like. Using the above-described method, the optical modulator 100 including the cavity C can be manufactured.

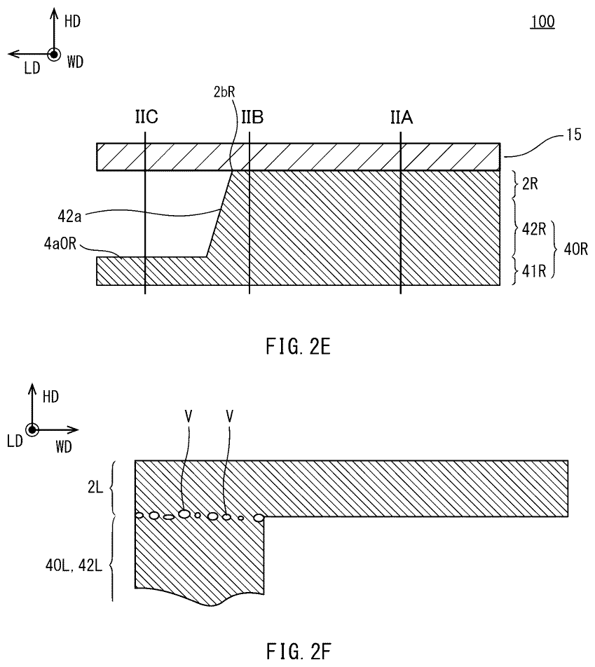

FIGS. 4A to 4G are schematic diagrams illustrating another example of the method of manufacturing the optical modulator 100. As illustrated in FIG. 4A, the recess portion 61 is formed on the prepared support substrate 6 using the same or substantially the same methods as those illustrated in FIGS. 3B and 3C, and the first wiring electrodes 4OR and 4OL is formed in the recess portion 61.

Next, as illustrated in FIG. 4B, the recess portion 61 where the first wiring electrodes 4OR and 4OL are formed is filled with a sacrificial layer 70. The filling of the sacrificial layer 70 can be performed by, for example, CVD, vapor deposition, sputtering, spin coating, or the like.

Next, as illustrated in FIG. 4C, the first electrodes 2R and 2L are formed on the support substrate 6 where the sacrificial layer 70 is filled by sputtering, vapor deposition, epitaxial growth, or the like.

Next, as illustrated in FIG. 4D, the electro-optic material substrate 16 is adhered to the support substrate 6 where the first electrodes 2R and 2L are formed. The components can be adhered by, for example, bonding using metal, bonding using a conductive resin, or the like. Instead of adhering the electro-optic material substrate 16, a film of the electro-optic material may be formed on the support substrate 6 where the first electrodes 2R and 2L are formed by, for example, epitaxial growth, spin coating, or the like.

Next, as illustrated in FIG. 4E, the electro-optic material substrate 16 is patterned by, for example, lithography or the like, and the base layer 15 including the optical waveguide 1 is formed by, for example, dry etching, wet etching, cutting with a dicing machine, or the like.

Next, as illustrated in FIG. 4F, the second electrode 3 is formed on the base layer 15 including the optical waveguide 1 by, for example, sputtering, vapor deposition, epitaxial growth, or the like.

As illustrated in FIG. 4G, the sacrificial layer 70 is removed from the base layer 15 where the second electrode 3 is formed by, for example, dry etching, wet etching, or the like. Using the above-described method, the optical modulator including the cavity C can be manufactured.

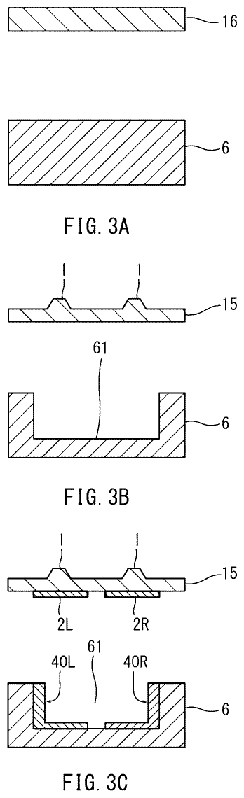

FIGS. 5A to 5F are schematic diagrams illustrating another example of the method of manufacturing the optical modulator 100. As illustrated in FIG. 5A, a C-SOI (Cavity Silicon On Insulator) 10 including the cavity C is prepared. Further, the base layer 15 including the optical waveguide 1 is prepared. Using the same or substantially the same method as the method illustrated in FIG. 3C, the first electrodes 2R and 2L are formed on the surface of the base layer 15.

Next, as illustrated in FIG. 5B, the base layer 15 is adhered to the C-SOI 10. The components can be adhered by, for example, bonding using metal, bonding using a conductive resin, or the like. Instead of adhering the base layer 15, the first electrodes 2R and 2L may be directly formed on the C-SOI 10, and a film of the electro-optic material may be formed on the surface thereof by, for example, epitaxial growth, spin coating, or the like.

Next, as illustrated in FIG. 5C, the back surface of the C-SOI 10 undergoes, for example, dry etching or wet etching. As a result, the cavity C is formed. The first wiring electrodes 4OR and 4OL are formed in the formed cavity C by, for example, sputtering, vapor deposition, epitaxial growth, or the like.

Next, as illustrated in FIG. 5D, the cavity C where the first wiring electrodes 4OR and 4OL are formed is filled with the sacrificial layer 70. The filling of the sacrificial layer 70 can be performed by, for example, CVD, vapor deposition, sputtering, spin coating, or the like.

Next, as illustrated in FIG. 5E, a film 71 for sealing is formed on the surface of the sacrificial layer 70. The formation of the film 71 can be performed by, for example, sputtering, CVD, vapor deposition or the like.

Next, as illustrated in FIG. 5F, the sacrificial layer 70 is removed. The removal of the sacrificial layer 70 can be performed by, for example, dry etching, wet etching, or the like. Next, using the same or substantially the same method as that illustrated in FIG. 3E, the second electrode 3 is formed on the base layer 15 including the optical waveguide 1. Using the above-described method, the optical modulator 100 including the cavity C can be manufactured.

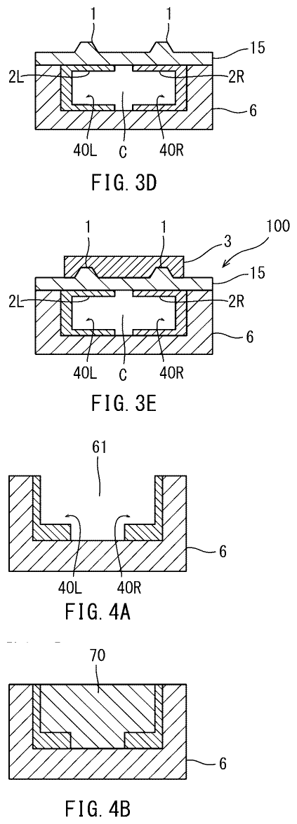

FIGS. 6A to 6G are schematic diagrams illustrating another example of the method of manufacturing the optical modulator 100. As illustrated in FIG. 6A, the support substrate 6 where the second electrode 3, the base layer 15 including the optical waveguide 1, and the first electrodes 2R and 2L are laminated in this order is prepared.

Next, as illustrated in FIG. 6B, the sacrificial layer 70 is laminated on the first electrodes 2R and 2L. The lamination of the sacrificial layer 70 can be performed by, for example, CVD, vapor deposition, sputtering, spin coating, or the like.

Next, as illustrated in FIG. 6C, through-holes 72 and 72 that extend to the first electrodes 2R and 2L are formed in the sacrificial layer 70. The formation of the through-holes 72 and 72 can be performed by, for example, performing patterning by lithography or the like and subsequently performing dry etching, wet etching, cutting with a dicing machine, or the like.

Next, as illustrated in FIGS. 6D and 6E, the first wiring electrodes 4OR and 4OL are formed in the through-holes 72 and 72 by, for example, sputtering, vapor deposition, epitaxial growth, or the like.

Next, as illustrated in FIG. 6F, a film for sealing is formed on the first wiring electrodes 4OR and 4OL. The formation of the film can be performed by, for example, sputtering, CVD, vapor deposition or the like.

Next, as illustrated in FIG. 6G, the sacrificial layer 70 present inside the first wiring electrodes 4OR and 4OL is removed. As a method of removing the sacrificial layer 70, the above-described method can be used. Using the above-described method, the optical modulator 100 including the cavity C can be manufactured.

### Advantageous Effects

In the optical modulator 100 according to the present example embodiment, the first electrodes 2R and 2L are disposed on one side of the optical waveguide 1 in the height direction HD of the optical modulator 100. The first wiring electrodes 4IR, 4IL, 4OR, and 4OL that supply an electrical signal to the first electrodes 2R and 2L or extract an electrical signal from the first electrodes 2R and 2L include the wiring portions 4aIR, 4aIL, 4aOR, and 4aOL that are disposed to be led out from the end portions 2aR, 2aL, 2bR, and 2bL of the first electrodes 2R and 2L when seen along the height direction HD, and are disposed on a side of the first electrodes 2R and 2L opposite to the optical waveguide 1 in the height direction HD. On the other hand, the second electrode 3 to apply an electric field to the optical waveguide 1 together with the first electrodes 2R and 2L together with the first electrode is disposed on the side opposite to the first electrodes 2R and 2L and the first wiring electrodes 4IR, 4IL, 4OR, and 4OL in the height direction HD of the optical modulator 100. Therefore, a wiring electrode to supply an electrical signal to the second electrode 3 or extract an electrical signal from the second electrode 3 naturally becomes spaced away from the wiring portions 4aIR, 4aIL, 4aOR, and 4aOL of the first wiring electrodes 4IR, 4IL, 4OR, and 4OL in the height direction HD of the optical modulator 100. As a result, an electric field is not likely to be generated between the wiring electrodes, and an excess electric field can be reduced or prevented from being applied particularly to a portion of the optical waveguide 1 other than the optical modulation portion. Accordingly, electrical loss can be reduced while reducing or preventing an increase in size of the optical modulator 100, in particular, an increase in size in a width direction.

In the optical modulator 100 according to the present example embodiment, the first electrodes 2R and 2L are provided in the cavity C. The cavity C is disposed on the first electrodes 2R and 2L side of the optical waveguide 1 in the height direction HD of the optical modulator 100, and accommodates the first electrodes 2R and 2L. In this case, the first wiring electrodes 4IR, 4IL, 4OR, and 4OL can be relatively freely disposed using the cavity C.

In the present example embodiment, the first wiring electrodes 4IR, 4IL, 4OR, and 4OL are disposed on sides of the first electrodes 2R and 2L opposite to the optical waveguide 1 in the height direction HD of the optical modulator 100. Therefore, even in a case where the wiring portions 4aIR, 4aIL, 4aOR, and 4aOL of the first wiring electrodes 4IR, 4IL, 4OR, and 4OL cross the optical waveguide 1 when seen along the height direction HD of the optical modulator 100, the wiring portions 4aIR, 4aIL, 4aOR, and 4aOL can be disposed at positions spaced away from the optical waveguide 1 in the height direction HD of the optical modulator 100. In this case, an excess electric field is not applied to the optical waveguide 1 from the wiring portions 4aIR, 4aIL, 4aOR, and 4aOL of the first wiring electrodes 4IR, 4IL, 4OR, and 4OL. Therefore, noise of the generated signal can be reduced. In addition, absorption of light from the optical waveguide 1 by the wiring portions 4aIR, 4aIL, 4aOR, and 4aOL can be reduced. Therefore, loss of light transmitted through the optical waveguide 1 can be reduced, and output of a laser that supplies a light wave to the optical waveguide 1 can be reduced or prevented. Therefore, power consumption can be reduced.

In the present example embodiment, the wiring portions 4aIR, 4aIL, 4aOR, and 4aOL of the first wiring electrodes 4IR, 4IL, 4OR, and 4OL extend from the first electrodes 2R and 2L toward one side in the width direction WD, and are disposed in parallel or substantially parallel in a plan view of the optical modulator 100. In this case, it is not necessary to widely extend the first wiring electrodes 4IR, 4IL, 4OR, and 4OL. Therefore, loss of an electrical signal can be reduced, and the footprint can be reduced. In addition, by disposing the wiring portions 4aIR, 4aIL, 4aOR, and 4aOL of the first wiring electrodes 4IR, 4IL, 4OR, and 4OL in parallel or substantially in parallel, electrical connection between the wiring portions 4aIR, 4aIL, 4aOR, and 4aOL and a digital signal processor or driver can be simplified.

In the present example embodiment, the first wiring electrodes 4IR, 4IL, 4OR, and 4OL that do not apply an electric field to the optical waveguide 1 are spaced away from the optical waveguide 1 in the height direction HD. Therefore, there is substantially no effect of the first wiring electrodes 4IR, 4IL, 4OR, and 4OL on the optical waveguide 1, and an electric field can be uniformly applied to the branched optical waveguide 12L and 12R by the first electrodes 2L and 2R and the second electrode 3. As a result, the amount of light leaking from the optical waveguide 1 during ON/OFF of a voltage can be reduced, and an extinction ratio of the optical modulator 100 can be improved.

For example, in the optical modulator 100, when the optical modulator 100 is formed in a state where an internal stress is generated due to, for example, the formation, coupling, or the like of the first wiring electrodes 4IR, 4IL, 4OR, and 4OL such that the first wiring electrodes 4IR, 4IL, 4OR, and 4OL cannot endure the internal stress during use of the optical modulator 100, buckling of the first wiring electrodes 4IR, 4IL, 4OR, and 4OL may occur. When the buckling of the first wiring electrodes 4IR, 4IL, 4OR, and 4OL occurs, not only the first wiring electrodes 4IR, 4IL, 4OR, and 4OL but also the first electrodes 2R and 2L are buckled, and thus the entire optical modulator 100 is deformed. In the present example embodiment, the first wiring electrodes 4IR, 4IL, 4OR, and 4OL are supported by the side walls 61a and 61a. Therefore, the buckling of the first wiring electrodes 4IR, 4IL, 4OR, and 4OL can be reduced or prevented. As a result, deformation of the optical modulator 100 can be reduced or prevented.

For example, in the connection portions 42R and 42L that connect the first electrodes 2R and 2L and the main body portions 41R and 41L of the first wiring electrodes 4IR, 4IL, 4OR, and 4OL, in a case where the surface 42a that is continuous to the end portion in the extension direction of the first electrodes 2R and 2L is disposed parallel or substantially parallel to the height direction HD of the optical modulator 100 when seen along the width direction WD of the optical modulator 100, a right-angled corner portion is provided between this surface 42a and the end portion of the first electrode 2R, and loss of a high frequency signal occurs in the corner portion. However, in the present example embodiment, the surface 42a of the connection portion 42R of the first wiring electrode 4OR is inclined with respect to the height direction HD such that the main body portions 41R and 41L side with respect to the first electrodes 2R and 2L side become spaced away from the first electrodes 2R and 2L in the extension direction when seen along the width direction WD of the optical modulator 100. Therefore, the surfaces 42a of the connection portions 42R and 42L of the first wiring electrodes 4OR and 4OL can be made continuous to the first electrodes 2R and 2L at a gentle angle. As a result, loss of a high frequency signal at boundaries between the surfaces 42a of the connection portions 42R and 42L and the first electrodes 2R and 2L can be reduced. As a result, modulation in a broad band can be achieved.

In the optical modulator 100 according to the present example embodiment, when the first electrodes 2R and 2L are coupled to the first wiring electrodes 4OR and 4OL, the fine void V may be provided at interfaces between the first electrodes 2R and 2L and the connection portions 42R and 42L. In this case, a capacitance can be added by the void V. Therefore, characteristic impedance can be adjusted. In addition, the void V has a lower dielectric constant than an electro-optic material. Therefore, an effective refractive index of an electrical signal can be reduced, and loss of an electrical signal in the first electrodes 2R and 2L and the first wiring electrodes 4OR and 4OL can be reduced.

When the first electrodes 2R and 2L are coupled to the first wiring electrodes 4OR and 4OL, oxygen may be provided at interfaces between the first electrodes 2R and 2L and the connection portions 42R and 42L. In this case, a capacitance can be added by the oxygen. Therefore, characteristic impedance can be adjusted. In addition, when oxygen is coupled with a metal to be provided as an oxide, the dielectric constant thereof is lower than that of an electro-optic material. Therefore, an effective refractive index of an electrical signal can be reduced, and loss of an electrical signal in the first electrodes 2R and 2L and the first wiring electrodes 4OR and 4OL can be reduced.

When the first electrodes 2R and 2L are coupled to the first wiring electrodes 4OR and 4OL, a eutectic may be provided at interfaces between the first electrodes 2R and 2L and the connection portions 42R and 42L. In this case, a coupling strength between the first electrodes 2R and 2L and the first wiring electrodes 4OR and 4OL can be increased. In addition, loss of electrical connection between the first electrodes 2R and 2L and the first wiring electrodes 4OR and 4OL can be reduced.

When the first electrodes 2R and 2L are coupled to the first wiring electrodes 4OR and 4OL, a resin may be provided at interfaces between the first electrodes 2R and 2L and the connection portions 42R and 42L. In this case, a capacitance can be added by the resin. Therefore, characteristic impedance can be adjusted. In addition, the resin has a lower dielectric constant than an electro-optic material. Therefore, effective refractive index of an electrical signal can be reduced, and loss of an electrical signal in the first electrodes 2R and 2L and the first wiring electrodes 4OR and 4OL can be reduced.

In the present example embodiment, the width w2 of the first electrodes 2R and 2L is preferably greater than the width w1 of the optical waveguide 1. In this case, an uniform electric field can be applied to the optical waveguide 1. Accordingly, the integrity of the generated optical signal is improved.

The optical modulator 100 according to the present example embodiment can include the support substrate 6. The support substrate 6 is disposed on a side of the first electrodes 2R and 2L opposite to the optical waveguide 1. It is preferable that the support substrate 6 is made of a low dielectric constant material having a refractive index lower than a refractive index of the optical waveguide 1. As a result, the effective refractive index of a high frequency signal can be adjusted to match with the effective refractive index of a light wave. Therefore, optical modulation in a broader band can be performed. In addition, the effective dielectric constant to an electrical signal can be reduced. Therefore, loss of a high frequency signal can be reduced or prevented, and optical modulation can be performed up to a higher frequency.

### Second Example Embodiment

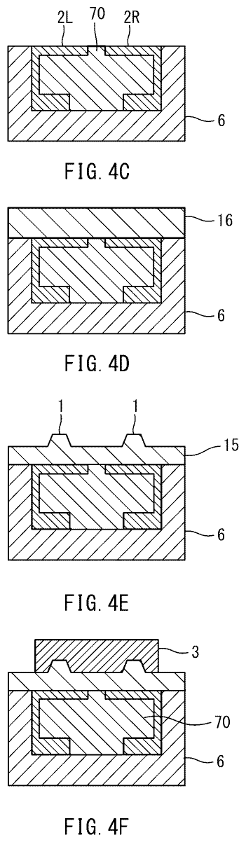

A configuration of an optical modulator 100A according to a second example embodiment of the present invention will be described with reference to FIG. 7. FIG. 7 is a schematic diagram illustrating the configuration of the optical modulator 100A according to the second example embodiment, and is a cross-sectional view corresponding to FIG. 2A. In other words, FIG. 7 is a cross-sectional view when the optical modulator 100A is cut along a surface perpendicular or substantially perpendicular to the longitudinal direction LD at positions of the linear portions 122R and 122L of the branched optical waveguides 12R and 12L. The optical modulator 100A is different from the optical modulator 100 according to the first example embodiment in the configuration of the connection portions 42R and 42L of the first wiring electrodes 4OR and 4OL.

As illustrated in FIG. 7, when seen in a cross-section perpendicular or substantially perpendicular to the extension direction (longitudinal direction LD) of the first electrodes 2R and 2L, the connection portions 42R and 42L of the first wiring electrodes 4OR and 4OL are inclined with respect to the height direction HD of the optical modulator 100A. The connection portions 42R and 42L are inclined toward the inside in the width direction WD with respect to the height direction HD as the distance to the main body portions 41R and 41L decreases. The connection portions 42R and 42L are provided along the side walls 61a and 61a defining the cavity C. The surfaces of the side walls 61a and 61a are also inclined as in the connection portions 42R and 42L.

In the optical modulator 100A according to the present example embodiment, the connection portions 42R and 42L are inclined with respect to the height direction HD when seen in the cross-section perpendicular or substantially perpendicular to the longitudinal direction LD. Therefore, the first wiring electrodes 4OR and 4OL can be coupled to the first electrodes 2R and 2L at a gentle angle θ. As a result, loss of a high frequency signal in the coupling portion between the first electrodes 2R and 2L and the first wiring electrodes 4OR and 4OL can be reduced, and modulation in a broad band can be achieved.

### Third Example Embodiment

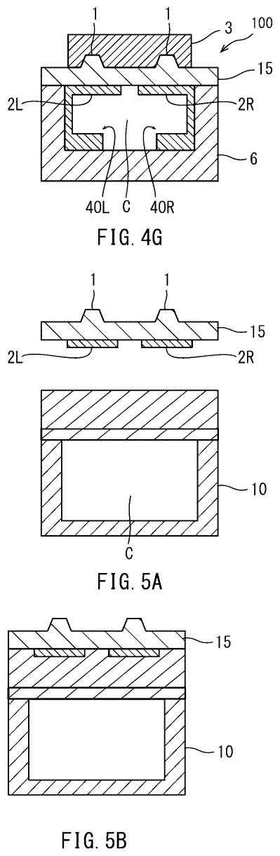

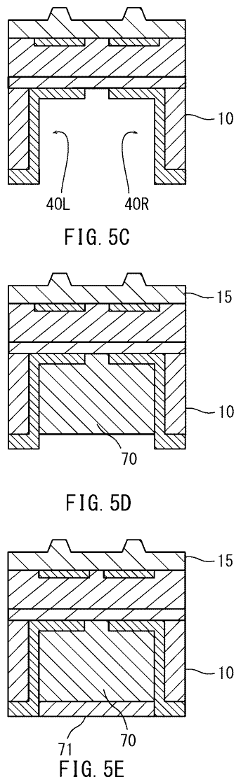

A configuration of an optical modulator 100B according to a third example embodiment of the present invention will be described with reference to FIGS. 8 and 9. FIG. 8 is a cross-sectional view corresponding to FIG. 2A. In other words, FIG. 8 is a cross-sectional view when the optical modulator 100B is cut along a surface perpendicular or substantially perpendicular to the longitudinal direction LD at positions of the linear portions 122R and 122L of the branched optical waveguides 12R and 12L (the optical modulation portions of the optical waveguide 1). FIG. 9 is a cross-sectional view corresponding to FIG. 2E. In other words, FIG. 9 is a cross-sectional view when the optical modulator 100B is cut along a surface perpendicular or substantially perpendicular to the width direction WD, and is a diagram illustrating the first electrodes 2R and 2L and the first wiring electrodes 4OR and 4OL when seen along the width direction WD. The optical modulator 100B is different from the optical modulator 100 according to the first example embodiment in the configuration of the first wiring electrodes 4OR and 4OL.

As illustrated in FIGS. 8 and 9, the first wiring electrodes 4OR and 4OL are not provided in a cross-section of the position of the optical modulation portion of the optical waveguide 1. The first wiring electrodes 4OR and 4OL are connected to only the end portions in the extension direction of the first electrodes 2R and 2L. As in the above-described first example embodiment, the connection portion 42R of the first wiring electrode 4OR includes the surface 42a that is continuous to the end portion in the extension direction (longitudinal direction LD) of the first electrode 2R. In addition, in the present example embodiment, when seen along the width direction WD, the surface of the connection portion 42R of the first wiring electrode 4OR opposite to the surface 42a is inclined with respect to the height direction HD as in the surface 42a. Accordingly, as in the third example embodiment, loss of a high frequency signal at boundaries between the surfaces 42a of the connection portions 42R and 42L and the first electrodes 2R and 2L can be reduced.

### Fourth Example Embodiment

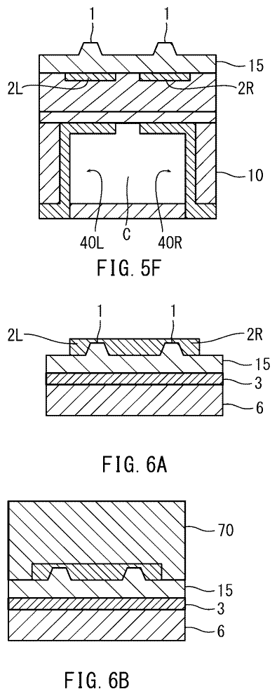

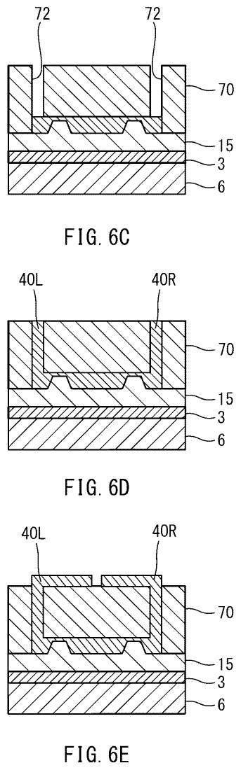

A configuration of an optical modulator 100C according to a fourth example embodiment of the present invention will be described with reference to FIGS. 10 and 11. FIG. 10 is a plan view illustrating the optical modulator 100C according to the fourth example embodiment. FIG. 11 is a cross-sectional view illustrating the configuration of the optical modulator 100C according to the fourth example embodiment. The optical modulator 100C is different from the optical modulator 100 according to the first example embodiment in the configuration of the first wiring electrodes 4OR and 4OL.

As illustrated in FIGS. 10 and 11, the first electrodes 2R and 2L are provided in a region of the linear portions 122R and 122L in the branched optical waveguides 12R and 12L. The first electrodes 2R and 2L and the first wiring electrodes 4OR and 4OL are disposed in the cavity C. At least a portion of the first wiring electrodes 4OR and 4OL is self-supporting in the cavity C. More specifically, the connection portions 42R and 42L of the first wiring electrodes 4OR and 4OL are self-supporting in the cavity C. Specifically, the connection portions 42R and 42L are disposed at positions spaced away from the side walls 61a and 61a defining the cavity C, and are not in contact with the side walls 61a and 61a. On the other hand, the main body portions 41R and 41L of the first wiring electrodes 4OR and 4OL are provided along the bottom wall 61b defining the cavity C.

In the optical modulator 100C according to the present example embodiment, the connection portions 42R and 42L of the first wiring electrodes 4OR and 4OL are self-supporting and disposed in the cavity C. The connection portions 42R and 42L are not in contact with the side walls 61a and 61a of the cavity C. Therefore, even when the surfaces of the side walls 61a and 61a are roughened, for example, by processing, there is no adverse effect on the first wiring electrodes 4OR and 4OL. That is, the first wiring electrodes 4OR and 4OL do not peel off from the side walls 61a and 61a, and loss of an electrical signal caused by surface roughness does not also occur.

### Fifth Example Embodiment

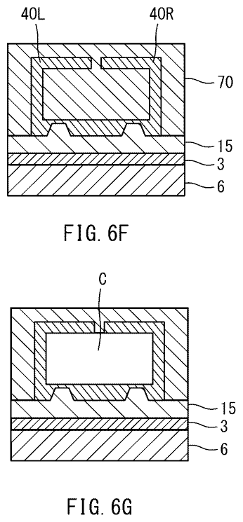

A configuration of an optical modulator 100D according to a fifth example embodiment of the present invention will be described with reference to FIG. 12. FIG. 12 is a cross-sectional view illustrating the configuration of the optical modulator 100D according to the fifth example embodiment. The optical modulator 100D is different from the optical modulator 100C according to the fourth example embodiment in the configuration of the first wiring electrodes 4OR and 4OL.

As illustrated in FIG. 12, the main body portions 41R and 41L of the first wiring electrodes 4OR and 4OL are disposed outside the cavity C. The connection portions 42R and 42L of the first wiring electrodes 4OR and 4OL penetrate the bottom wall 61b defining the cavity C and are connected to the main body portions 41R and 41L. A portion of the connection portions 42R and 42L is self-supporting in the cavity C. Accordingly, the optical modulator 100D according to the fifth example embodiment has the same advantageous effects as the optical modulator 100C according to the fourth example embodiment.

### Sixth Example Embodiment

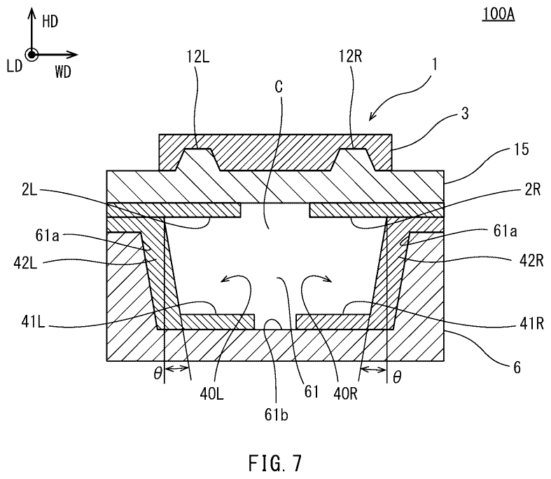

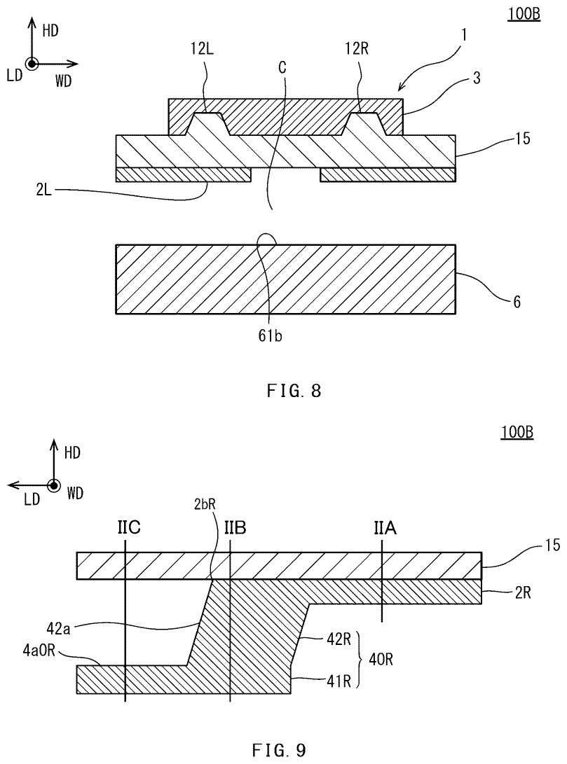

A configuration of an optical modulator 100E according to a sixth example embodiment of the present invention will be described with reference to FIGS. 13 and 14. FIG. 13 is a plan view illustrating the optical modulator 100E according to the sixth example embodiment. FIG. 14 is a cross-sectional view taken along a line XIV-XIV in FIG. 13. In other words, FIG. 14 illustrates a cross-section when the first wiring electrode 4OL extending from the first electrode 2L in the width direction WD is cut along a surface perpendicular or substantially perpendicular to the longitudinal direction LD, and a cross-section when the optical modulator 100E is cut along the surface perpendicular or substantially perpendicular to the longitudinal direction LD at positions of the linear portions 122R and 122L of the branched optical waveguides 12R and 12L. The optical modulator 100E is different from the optical modulator 100 according to the first example embodiment, in that the optical modulator 100E includes through-electrodes 8IR, 8IL, 8OR, and 8OL.

As illustrated in FIGS. 13 and 14, the optical modulator 100E includes the through-electrodes 8IR, 8IL, 8OR, and 8OL. The through-electrodes 8IR, 8IL, 8OR, and 8OL are connected to end portions of the wiring portions 4aIR, 4aIL, 4aOR, and 4aOL of the first wiring electrodes 4IR, 4IL, 4OR, and 4OL. More specifically, the through-electrodes 8IR, 8IL, 8OR, and 8OL are connected to the end portions of the wiring portions 4aIR, 4aIL, 4aOR, and 4aOL of the main body portions 41R and 41L of the first wiring electrodes 4OR and 4OL. That is, the through-electrodes 8IR, 8IL, 8OR, and 8OL are electrically connected to the first electrodes 2R and 2L through the first wiring electrodes 4OR and 4OL. The through-electrodes 8IR, 8IL, 8OR, and 8OL extend from the first electrodes 2R and 2L side toward the second electrode 3 side. In the example of the present example embodiment, the through-electrodes 8IR, 8IL, 8OR, and 8OL extend along the height direction HD. In this case, an electrical signal of the first electrodes 2R and 2L is extracted to the second electrode 3 side through the through-electrodes 8IR, 8IL, 8OR, and 8OL, or is supplied to the first electrodes 2R and 2L through the through-electrodes 8IR, 8IL, 8OR, and 8OL. In the example of the present example embodiment, the through-electrodes 8IR, 8IL, 8OR, and 8OL penetrate the base layer 15 where the optical waveguide 1 is provided.

In the optical modulator 100E according to the present example embodiment, an electrode pad for the first electrodes 2R and 2L and an electrode pad for the second electrode 3 can be disposed on the same plane, and electrode wirings can be simplified. In addition, the electrode wirings for the first electrodes 2R and 2L and the electrode wirings for the second electrode 3 can be disposed close to each other, and loss of an electrical signal can be reduced.

### Seventh Example Embodiment

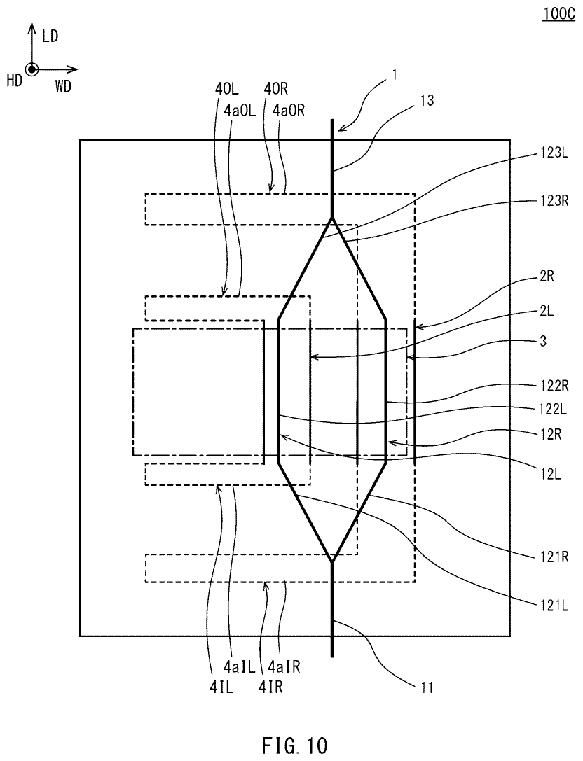

A configuration of an optical modulator 100F according to a seventh example embodiment of the present invention will be described with reference to FIG. 15. FIG. 15 is a cross-sectional view illustrating the configuration of the optical modulator 100F according to the seventh example embodiment, and is a cross-sectional view corresponding to FIG. 14. The optical modulator 100F is different from the optical modulator 100E according to the sixth example embodiment in the configuration of the through-electrodes 8IR, 8IL, 8OR, and 8OL.

As illustrated in FIG. 15, the through-electrodes 8OR and 8OL are provided along a side wall 61a defining the cavity C. The through-electrodes 8OR and 8OL are inclined with respect to the height direction HD of the optical modulator 100F. More specifically, surfaces 811 of the through-electrodes 8OR and 8OL in contact with the side wall 61a are inclined toward the inside in the width direction WD with respect to the height direction HD as the distance to the bottom wall 61b side decreases. The surface of the side wall 61a is inclined as in the through-electrodes 8OR and 8OL.

In the optical modulator 100F according to the present example embodiment, the through-electrodes 8IR, 8IL, 8OR, and 8OL are inclined with respect to the height direction HD. Therefore, the surfaces 811 of the through-electrodes 8IR, 8IL, 8OR, and 8OL can be gently coupled to the first electrodes 2R and 2L. As a result, loss of a high frequency signal in the coupling portion between the through-electrodes 8IR, 8IL, 8OR, and 8OL and the first wiring electrodes 4IR, 4IL, 4OR, and 4OL can be reduced, and modulation in a broad band can be achieved.

### Eighth Example Embodiment

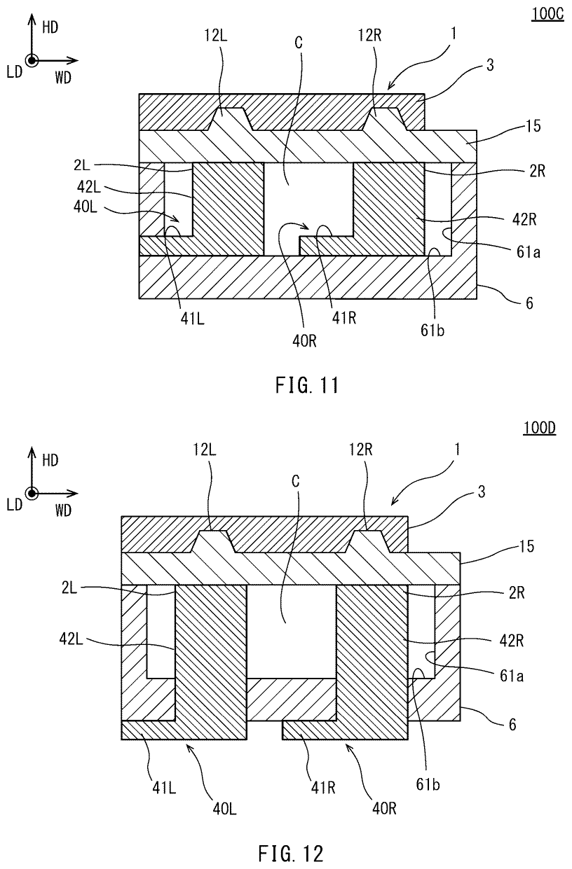

A configuration of an optical modulator 100G according to an eighth example embodiment of the present invention will be described with reference to FIG. 16. FIG. 16 is a cross-sectional view illustrating the configuration of the optical modulator 100G according to the eighth example embodiment. The optical modulator 100G is different from the optical modulator 100 according to the first example embodiment in the configurations of the first electrodes 2R and 2L and the first wiring electrodes 4OR and 4OL.

As illustrated in FIG. 16, a thickness t2 of the first electrodes 2R and 2L is greater than a thickness t4 of the first wiring electrodes 4OR and 4OL. The thickness t2 of the first electrodes 2R and 2L is the maximum dimension of the first electrodes 2R and 2L in the height direction HD. The thickness t4 of the first wiring electrodes 4OR and 4OL is the maximum thickness among a thickness t41 of the main body portions 41R and 41L and a thickness t42 of the connection portions 42R and 42L. The thickness t41 of the main body portions 41R and 41L is based on a surface of the bottom wall 61b of the recess portion 61 where the main body portions 41R and 41L are provided, and is the maximum dimension from the surface in a direction perpendicular or substantially perpendicular to the surface. The thickness t42 of the connection portions 42R and 42L is based on a surface of the side walls 61a and 61a of the recess portion 61 where the main connection portions 42R and 42L are provided, and is the maximum dimension from the surface in a direction perpendicular or substantially perpendicular to the surface.

In the optical modulator 100G according to the present example embodiment, the thickness t2 of the first electrodes 2R and 2L is greater than the thickness t4 of the first wiring electrodes 4IR, 4IL, 4OR, and 4OL. As a result, a resistance of the first electrodes 2R and 2L in a portion (linear portions 122R and 122L) of the optical modulator 100G where optical modulation is performed can be reduced, and thus loss of an electrical signal can be reduced.

### Ninth Example Embodiment

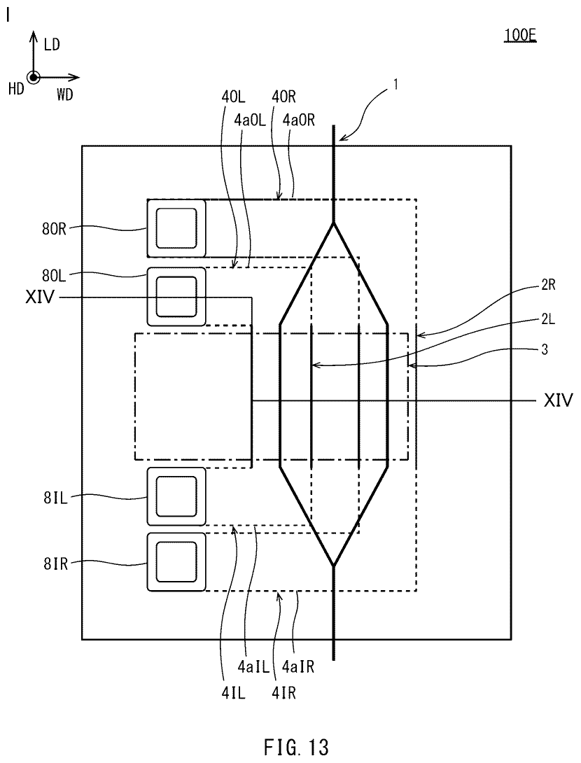

A configuration of an optical modulator 100H according to a ninth example embodiment of the present invention will be described with reference to FIG. 17. FIG. 17 is a cross-sectional view illustrating the configuration of the optical modulator 100H according to the ninth example embodiment. The optical modulator 100H is different from the optical modulator 100 according to the first example embodiment in that the optical modulator 100H includes a low dielectric constant layer 9.

As illustrated in FIG. 17, the optical modulator 100H includes the low dielectric constant layer 9 between the optical waveguide 1 and the second electrode 3. The low dielectric constant layer 9 has a refractive index lower than a refractive index of the optical waveguide 1. In the example of the present example embodiment, the low dielectric constant layer 9 is provided to cover the optical waveguide 1 and the base layer 15.

In the optical modulator 100H according to the present example embodiment, the low dielectric constant layer 9 is provided between the optical waveguide 1 and the second electrode 3. Therefore, light transmitted through the optical waveguide 1 is not likely to be absorbed by the second electrode 3, and loss of light can be reduced or prevented. In addition, by providing the low dielectric constant layer 9, the effective refractive index of a high frequency signal can be adjusted to match with the effective refractive index of a light wave. Therefore, optical modulation can be performed up to a higher frequency. Further, by providing the low dielectric constant layer 9, the effective dielectric constant to an electrical signal can be reduced. Therefore, loss of a high frequency signal can be reduced or prevented, and optical modulation can be performed up to a higher frequency.

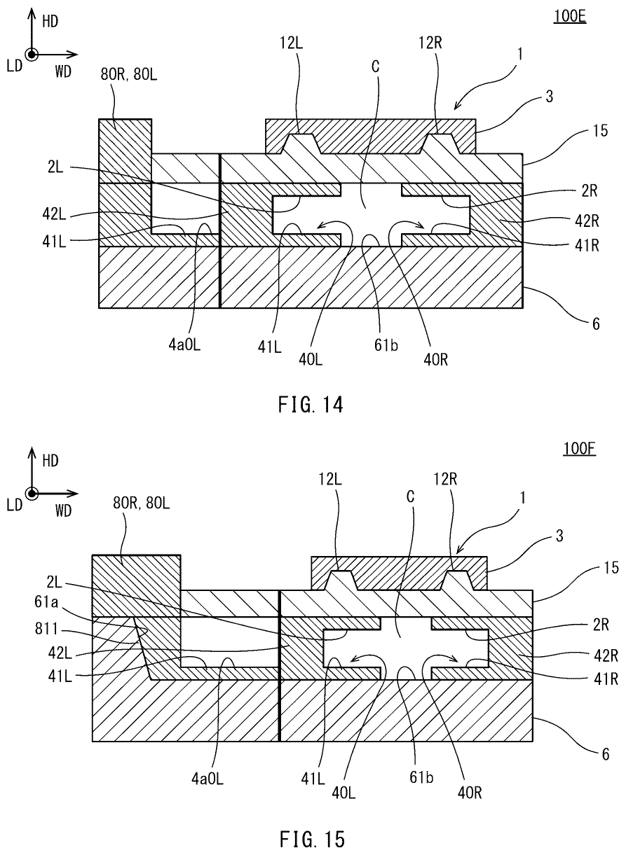

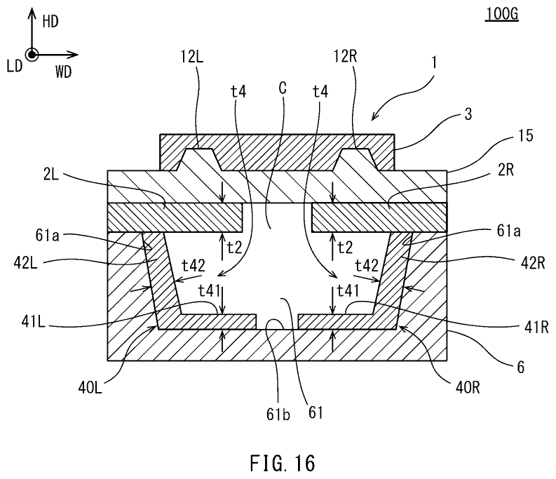

FIGS. 18 and 19 illustrate a modified example of the optical modulator 100H according to the ninth example embodiment. The optical modulator 100H illustrated in FIG. 18 includes a low dielectric constant layer 9A between the optical waveguide 1 and the first electrodes 2R and 2L. The optical modulator 100H illustrated in FIG. 19 includes the low dielectric constant layer 9 between the optical waveguide 1 and the second electrode 3, and further includes the low dielectric constant layer 9A between the optical waveguide 1 and the first electrodes 2R and 2L. In the example of the present example embodiment, the low dielectric constant layer 9A is provided between the base layer 15 and the first electrodes 2R and 2L. The low dielectric constant layer 9A makes light transmitted through the optical waveguide 1 difficult to be absorbed by the first electrodes 2R and 2L. In addition, as in the low dielectric constant layer 9, the effective refractive index of a high frequency signal can be adjusted, and the effective dielectric constant to an electrical signal can be reduced.

### Tenth Example Embodiment

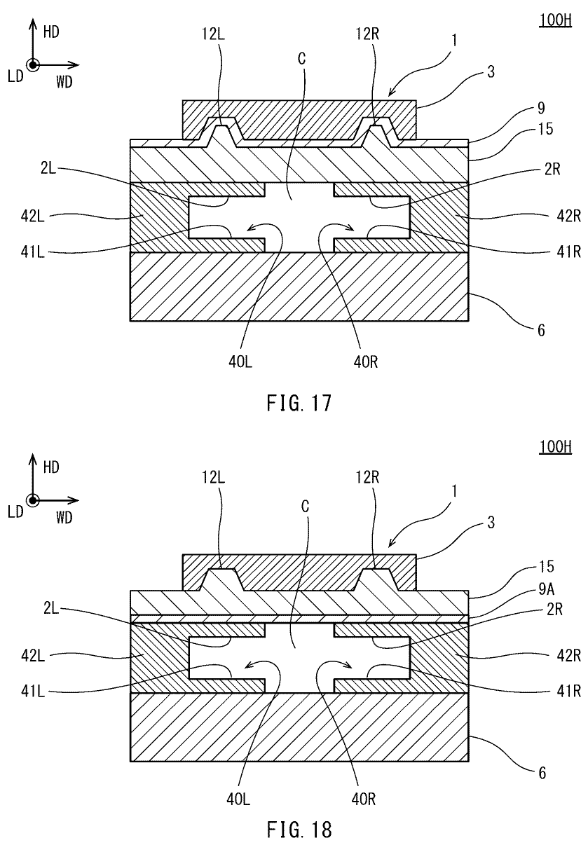

A configuration of an optical modulator 100I according to a tenth example embodiment of the present invention will be described with reference to FIG. 20. FIG. 20 is a cross-sectional view illustrating the configuration of the optical modulator 100I according to the tenth example embodiment. The optical modulator 100I is different from the optical modulator 100H according to the ninth example embodiment in the disposition of the cavity C relative to the optical waveguide 1.

As illustrated in FIG. 20, the optical waveguide 1, the first electrodes 2R and 2L, and the second electrode 3 are disposed on the support substrate 6. Specifically, the second electrode 3 is provided on the support substrate 6 side of the optical waveguide 1 with the low dielectric constant layer 9 interposed therebetween. The cavity C is defined by the low dielectric constant layer 9A that is disposed on the side of the optical waveguide 1 opposite to the support substrate 6. The first electrodes 2R and 2L and the first wiring electrodes 4IR, 4IL, 4OR, and 4OL are disposed in the cavity C. In this case, the cavity C can be disposed above the support substrate 6. When the cavity C is disposed above the support substrate 6, the cavity C can be provided using a cap covering the optical modulator 100I.

### Eleventh Example Embodiment

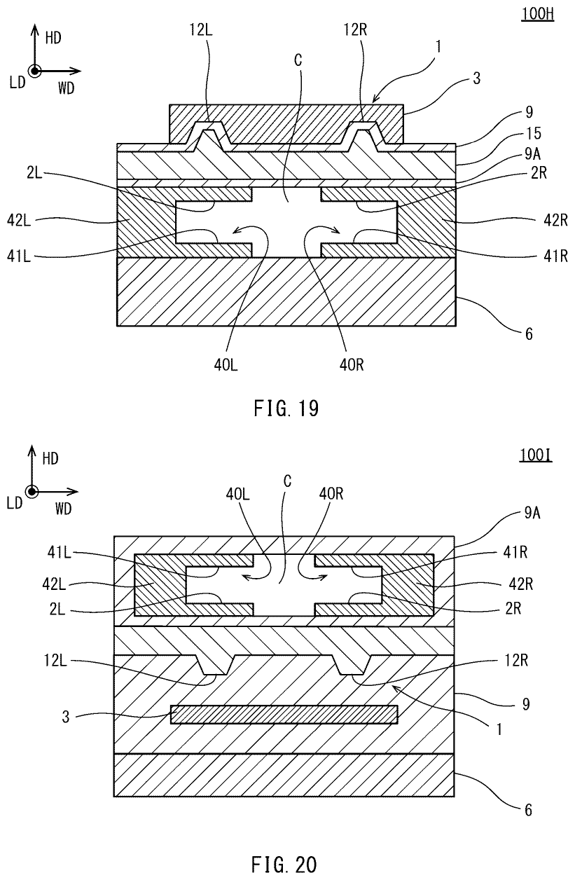

A configuration of an optical modulator 100J according to an eleventh example embodiment of the present invention will be described with reference to FIG. 21. FIG. 21 is a schematic diagram illustrating the configuration of the optical modulator 100J according to the eleventh example embodiment, and is a cross-sectional view corresponding to FIG. 2A. In other words, FIG. 21 is a cross-sectional view when the optical modulator 100J is cut along a surface perpendicular or substantially perpendicular to the longitudinal direction LD at positions of the linear portions 122R and 122L of the branched optical waveguides 12R and 12L. The optical modulator 100J is different from the optical modulator 100 according to the first example embodiment in the disposition of the first electrodes 2R and 2L and the second electrode 3 relative to the optical waveguide 1.

As illustrated in FIG. 21, the first electrodes 2R and 2L are disposed on one side of the optical waveguide 1 in the height direction HD. The first electrodes 2R and 2L are disposed, for example, immediately above the branched optical waveguides 12R and 12L, respectively. On the other hand, the second electrode 3 is disposed on another side of the optical waveguide 1 in the height direction HD. For example, among both surfaces of the base layer 15, the second electrode 3 is disposed on the surface opposite to the ridge type optical waveguide 1. In addition, the second electrode 3 is disposed on the support substrate 6.

As in the first example embodiment, the first wiring electrodes 4OR and 4OL are electrically connected to the first electrodes 2R and 2L. The first wiring electrodes 4OR and 4OL are disposed on the side of the first electrodes 2R and 2L opposite to the optical waveguide 1 in the height direction HD. More specifically, the main body portions 41R and 41L of the first wiring electrodes 4OR and 4OL are spaced away from the first electrodes 2R and 2L in the height direction HD. In addition, the main body portions 41R and 41L are disposed at positions deviating outward from the first electrodes 2R and 2L in the width direction WD. The connection portions 42R and 42L of the first wiring electrodes 4OR and 4OL connect the main body portions 41R and 41L to the first electrodes 2R and 2L. The connection portions 42R and 42L connect, for example, outer side end portions in the width direction WD of the first electrodes 2R and 2L and inner side end portions in the width direction WD of the main body portions 41R and 41L to each other.

In the present example embodiment, the low dielectric constant layer 9A is provided in a range from the optical waveguide 1 to the first electrodes 2R and 2L in the height direction HD. The low dielectric constant layer 9A is also provided in a range from the optical waveguide 1 to the first wiring electrodes 4OR and 4OL in the height direction HD. A thickness t9A4 of the low dielectric constant layer 9A at the position of the first wiring electrodes 4OR and 4OL is greater than a thickness t9A2 of the low dielectric constant layer 9A at the position of the first electrodes 2R and 2L. The thickness t9A4 is a dimension in the height direction HD of the low dielectric constant layer 9A in the range from the optical waveguide 1 to the first wiring electrodes 4OR and 4OL, and is, for example, the shortest distance in the height direction HD from the optical waveguide 1 to the main body portions 41R and 41L of the first wiring electrodes 4OR and 4OL. The thickness t9A2 is a dimension in the height direction HD of the low dielectric constant layer 9A in the range from the optical waveguide 1 to the first electrodes 2R and 2L, and is, for example, the shortest distance in the height direction HD from the optical waveguide 1 to the first electrodes 2R and 2L. The thickness t9A4 of the low dielectric constant layer 9A at the position of the first wiring electrodes 4OR and 4OL is preferably two or more times the thickness t9A2 of the low dielectric constant layer 9A at the position of the first electrodes 2R and 2L.

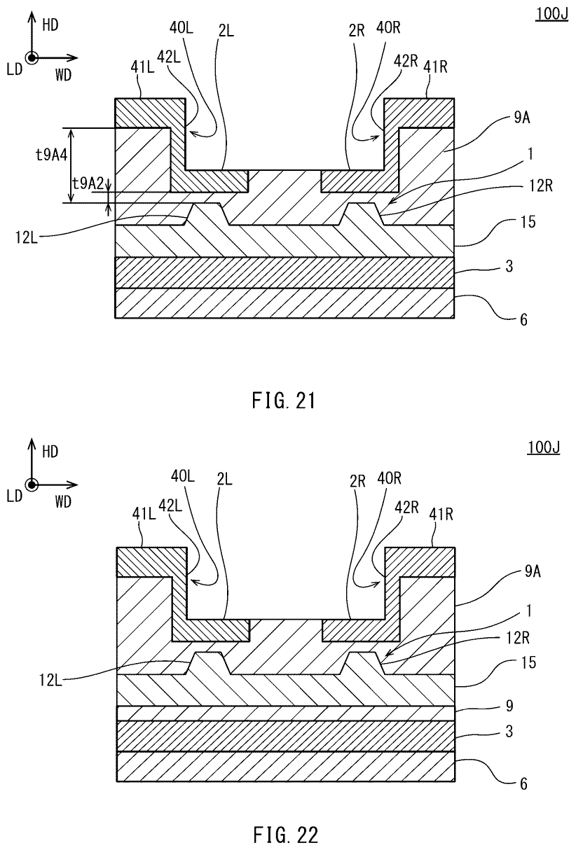

FIG. 22 illustrates a modified example of the optical modulator 100J according to the eleventh example embodiment. The optical modulator 100J illustrated in FIG. 22 includes the low dielectric constant layer 9A between the optical waveguide 1 and the first electrodes 2R and 2L. The optical modulator 100J further includes the low dielectric constant layer 9 between the optical waveguide 1 and the second electrode 3.

### Method of Manufacturing Optical Modulator 100J

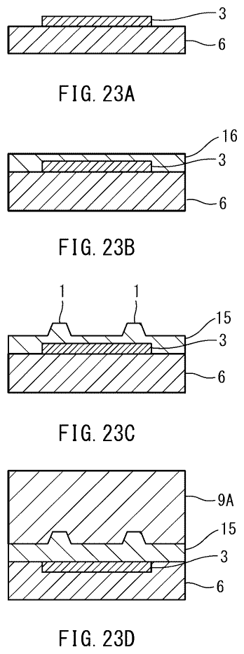

Hereinafter, an example of a method of manufacturing the optical modulator 100J will be described. FIGS. 23A to 23F are schematic diagrams illustrating an example of the method of manufacturing the optical modulator 100J. As illustrated in FIG. 23A, the second electrode 3 is formed on the surface of the support substrate 6.

Next, as illustrated in FIG. 23B, the electro-optic material substrate 16 is adhered to the support substrate 6 where the second electrode 3 is formed on the surface. As an adhering method, the above-described bonding method can be used. Instead of adhering the electro-optic material substrate 16, a film of the electro-optic material may be formed by, for example, epitaxial growth, spin coating, or the like.

Next, as illustrated in FIG. 23C, the electro-optic material substrate 16 is patterned by, for example, lithography or the like, and undergoes, for example, dry etching, wet etching, cutting with a dicing machine, or the like. As a result, the base layer 15 including the optical waveguide 1 is formed.

Next, as illustrated in FIG. 23D, the low dielectric constant layer 9A is laminated on the base layer 15 including the optical waveguide 1. The low dielectric constant layer 9A can be formed by, for example, sputtering, vapor deposition, epitaxial growth, or the like.

Next, as illustrated in FIG. 23E, the low dielectric constant layer 9A is patterned by, for example, lithography or the like, and a recess portion 73 is formed by, for example, dry etching, wet etching, cutting with a dicing machine, or the like.

Next, as illustrated in FIG. 23F, the recess portion 73 undergoes, for example, sputtering, vapor deposition, epitaxial growth, or the like. As a result, the first electrodes 2R and 2L and the first wiring electrodes 4OR and 4OL are formed in the recess portion 73. Using the above-described method, the optical modulator 100J can be manufactured.

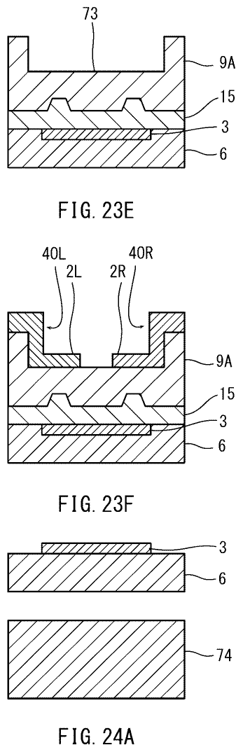

FIGS. 24A to 24F are schematic diagrams illustrating another example of the method of manufacturing the optical modulator 100J. As illustrated in FIG. 24A, the support substrate 6 where the second electrode 3 is formed on the surface is prepared. In addition, the support substrate 6 where the second electrode 3 is formed on the surface and another substrate 74 are prepared.

Next, as illustrated in FIG. 24B, the electro-optic material substrate 16 is adhered to the support substrate 6 as in the case illustrated in FIG. 23B. Alternatively, a film of an electro-optic material may be formed instead of adhering the electro-optic material substrate 16. On the other hand, the substrate 74 is patterned by, for example, lithography or the like, and undergoes, for example, dry etching, wet etching, cutting with a dicing machine, or the like. As a result, a protrusion portion 75 is formed in the substrate 74.

Next, as illustrated in FIG. 24C, the base layer 15 including the optical waveguide 1 is formed as in the case illustrated in FIG. 23C. On the other hand, the substrate 74 where the protrusion portion 75 is formed undergoes, for example, sputtering, vapor deposition, epitaxial growth, or the like, such that the first electrodes 2R and 2L and the first wiring electrodes 4OR and 4OL are formed around the protrusion portion 75.

Next, as illustrated in FIG. 24d, the low dielectric constant layer 9A is laminated on the protrusion portion 75 of the substrate 74. As a method of forming the low dielectric constant layer 9A, the above-described method can be used.

Next, as illustrated in FIG. 24E, the support substrate 6 where the optical waveguide 1 is formed is adhered to the substrate 74 where the low dielectric constant layer 9A is formed. As an adhering method, the above-described bonding method can be used.

Next, the substrate 74 is removed as illustrated in FIG. 24F. The removal of the substrate 74 can be performed by, for example, dry etching, wet etching, or the like. Using the above-described method, the optical modulator 100J can be manufactured.

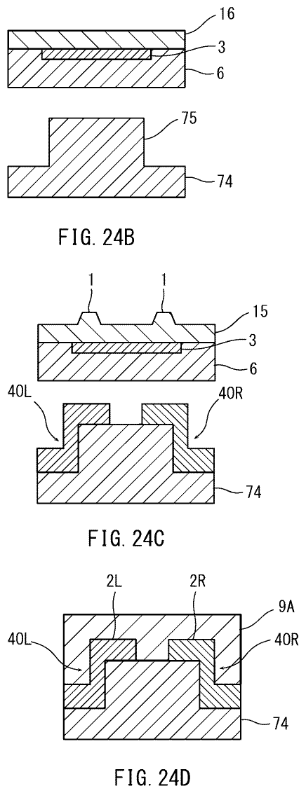

FIGS. 25A to 25E are schematic diagrams illustrating another example of the method of manufacturing the optical modulator 100J. As illustrated in FIG. 25A, the C-SOI 10 including the cavity C is prepared.

Next, as illustrated in FIG. 25B, the C-SOI 10 undergoes, for example, dry etching, wet etching, or the like to remove an active layer. Next, the base layer 15 including the optical waveguide 1 is prepared. In the base layer 15, the low dielectric constant layer 9A is laminated on a surface on the optical waveguide 1 side, and the second electrode 3 is formed on a surface opposite to the optical waveguide 1.

Next, as illustrated in FIG. 25C, the base layer 15 is adhered to the C-SOI 10.

Next, as illustrated in FIG. 25D, the back surface of the C-SOI 10 undergoes, for example, dry etching or wet etching to form the cavity C.

Next, as illustrated in FIG. 25E, the first wiring electrodes 4OR and 4OL are formed in the formed cavity C by, for example, sputtering, vapor deposition, epitaxial growth, or the like. Using the above-described method, the optical modulator 100J can be manufactured.

### Twelfth Example Embodiment

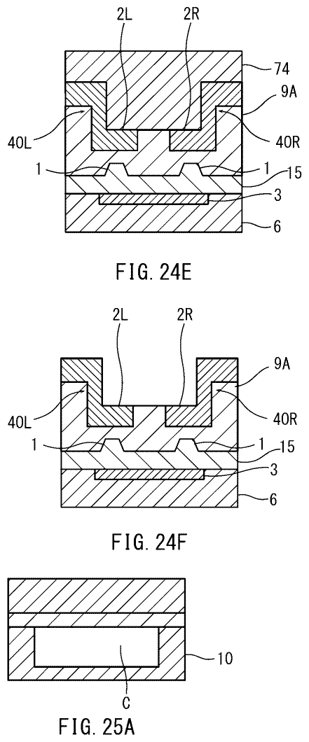

A configuration of an optical modulator 100K according to a twelfth example embodiment of the present invention will be described with reference to FIG. 26. FIG. 26 is a schematic diagram illustrating the configuration of the optical modulator 100K according to the twelfth example embodiment, and is a cross-sectional view corresponding to FIG. 2A. In other words, FIG. 26 is a cross-sectional view when the optical modulator 100K is cut along a surface perpendicular or substantially perpendicular to the longitudinal direction LD at positions of the linear portions 122R and 122L of the branched optical waveguides 12R and 12L. The optical modulator 100K is different from the optical modulator 100J according to the eleventh example embodiment in that the optical modulator 100K includes second wiring electrodes 5I and 5O.

As illustrated in FIG. 26, the optical modulator 100K includes the second wiring electrodes 5I and 5O. The second wiring electrodes 5I and 5O are electrically connected to the second electrode 3. The second wiring electrodes 5I and 5O are disposed on the side of the second electrode 3 opposite to the optical waveguide 1 in the height direction HD. The second wiring electrodes 5I and 5O include main body portions 51I and 51O and connection portions 52I and 52O.

The main body portions 51I and 51O are spaced away from the second electrode 3 in the height direction HD. In addition, the main body portions 51I and 51O are disposed at positions deviating outward from the second electrode 3 in the width direction WD. The connection portions 52I and 52O connect the main body portions 51I and 51O and the second electrode 3 to each other. The connection portions 52I and 52O connect, for example, an outer side end portion in the width direction WD of the second electrode 3 and inner side end portions in the width direction WD of the main body portions 51I and 51O to each other. The connection portions 52I and 52O may be parallel or substantially parallel to the height direction HD or may be inclined with respect to the height direction HD in a cross-sectional view of the optical modulator 100.

The main body portions 51I and 51O and the connection portions 52I and 52O can have, for example, a rectangular or substantially rectangular cross-section. The cross-sectional shape of the main body portions 51I and 51O and the connection portions 52I and 52O are not limited to this example.

In the present example embodiment, the low dielectric constant layer 9 is provided in a range from the optical waveguide 1 to the second electrode 3 in the height direction HD. The low dielectric constant layer 9 is also provided in a range from the optical waveguide 1 to the second wiring electrodes 5I and 5O. In this case, a thickness t95 of the low dielectric constant layer 9 at the position of the second wiring electrodes 5I and 5O is greater than a thickness t93 of the low dielectric constant layer 9 at the position of the second electrode 3. The thickness t95 is a dimension in the height direction HD of the low dielectric constant layer 9 in the range from the optical waveguide 1 to the second wiring electrodes 5I and 5O, and is, for example, the shortest distance in the height direction HD from the base layer 15 to the main body portions 51I and 51O of the second wiring electrodes 5I and 5O. The thickness t93 is a dimension in the height direction HD of the low dielectric constant layer 9A in the range from the optical waveguide 1 to the second electrode 3, and is, for example, the shortest distance in the height direction HD from the base layer 15 to the second electrode 3. The thickness t95 of the low dielectric constant layer 9 at the position of the second wiring electrodes 5I and 5O is preferably two or more times the thickness t93 of the low dielectric constant layer 9 at the position of the second electrode 3.

In the optical modulator 100K according to the present example embodiment, the second wiring electrodes 5I and 5O are disposed on the side of the second electrode 3 opposite to the optical waveguide 1. Therefore, the second wiring electrodes 5I and 5O can be naturally spaced away from the optical waveguide 1 and the first wiring electrodes 4IR, 4IL, 4OR, and 4OL in the height direction HD. Therefore, an electric field is not likely to be generated between the first wiring electrodes 4IR, 4IL, 4OR, and 4OL that do not apply an electric field to the optical waveguide 1 and the second wiring electrodes 5I and 5O, and an electric field generated by the first wiring electrodes 4IR, 4IL, 4OR, and 4OL and the second wiring electrodes 5I and 5O can be prevented from being applied to the optical waveguide 1. Therefore, electrical loss in the optical modulator 100K can be further reduced or prevented.

### Thirteenth Example Embodiment

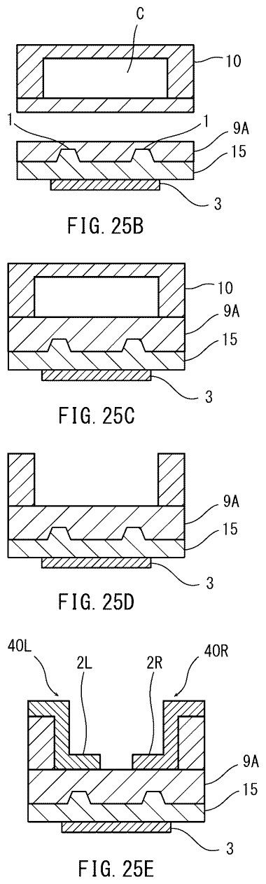

A configuration of an optical modulator 100L according to a thirteenth example embodiment of the present invention will be described with reference to FIG. 27. FIG. 27 is a cross-sectional view illustrating the configuration of the optical modulator 100L according to the thirteenth example embodiment. The optical modulator 100L is different from the optical modulator 100K according to the twelfth example embodiment in that the optical modulator 100L includes through-electrodes 8AI and 8AO.

As illustrated in FIG. 27, the optical modulator 100L includes the through-electrodes 8AI and 8AO. The through-electrodes 8AI and 8AO are connected to end portions of the second wiring electrodes 5I and 5O. More specifically, the through-electrodes 8AI and 8AO are connected to the main body portions 51I and 51O of the second wiring electrodes 5I and 5O. That is, the through-electrodes 8AI and 8AO are electrically connected to the second electrode 3 through the second wiring electrodes 5I and 5O. The through-electrodes 8AI and 8AO extend from the second electrode 3 side toward the first electrodes 2R and 2L side. In the example of the present example embodiment, the through-electrodes 8AI and 8AO extend along the height direction HD. In this case, an electrical signal of the second electrode 3 is extracted to the first electrodes 2R and 2L side through the through-electrodes 8AI and 8AO, or is supplied to the second electrode 3 through the through-electrodes 8AI and 8AO. In the example of the present example embodiment, the through-electrodes 8AI and 8AO penetrate the base layer 15 where the optical waveguide 1 is provided and the low dielectric constant layers 9 and 9A.

In the optical modulator 100L according to the present example embodiment, an electrode pad for the first electrodes 2R and 2L and an electrode pad for the second electrode 3 can be disposed on the same plane, and electrode wirings can be simplified. In addition, the electrode wirings for the first electrodes 2R and 2L and the electrode wirings for the second electrode 3 can be disposed close to each other, and loss of an electrical signal can be reduced or prevented.

### Fourteenth Example Embodiment

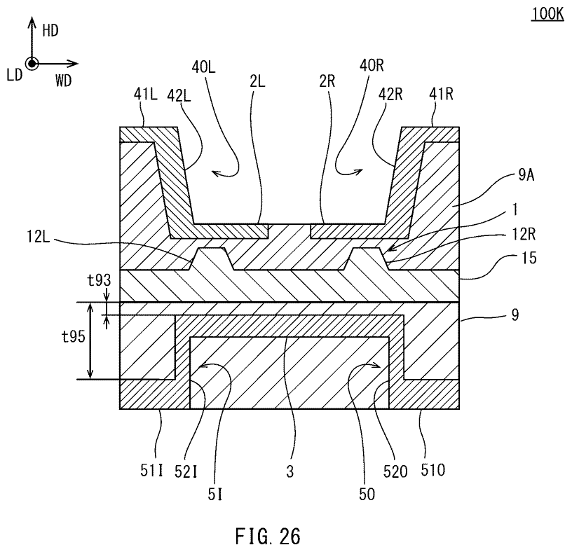

A configuration of an optical modulator 100M according to a fourteenth example embodiment of the present invention will be described with reference to FIG. 28. FIG. 28 is a cross-sectional view illustrating the configuration of the optical modulator 100M according to the fourteenth example embodiment. The optical modulator 100M is different from the optical modulator 100L according to the thirteenth example embodiment in the configuration of the through-electrodes 8AI and 8AO.

As illustrated in FIG. 28, the through-electrodes 8AI and 8AO are inclined with respect to the height direction HD of the optical modulator 100M. The through-electrodes 8AI and 8AO are inclined with respect to the height direction HD such that the second wiring electrodes 5I and 5O side are positioned inward in the width direction WD. The through-electrodes 8AI and 8AO penetrate the low dielectric constant layers 9 and 9A.

In the optical modulator 100M according to the present example embodiment, the through-electrodes 8AI and 8AO are inclined with respect to the height direction HD. Therefore, the through-electrodes 8AI and 8AO can be gently coupled to the second electrode 3. As a result, loss of a high frequency signal in the coupling portion between the through-electrodes 8AI and 8AO and the second electrode 3 can be reduced, and modulation in a broad band can be achieved.

### Fifteenth Example Embodiment

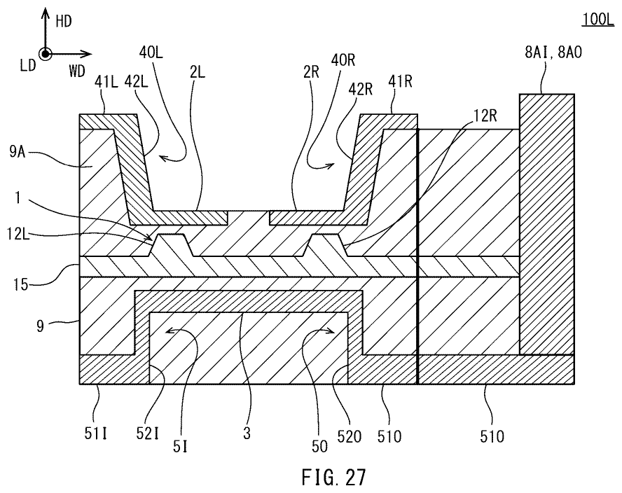

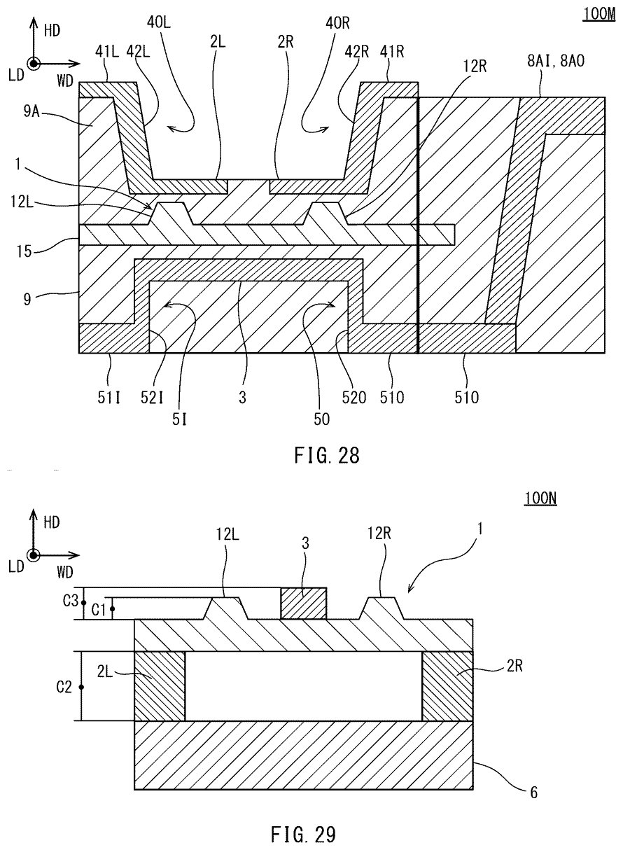

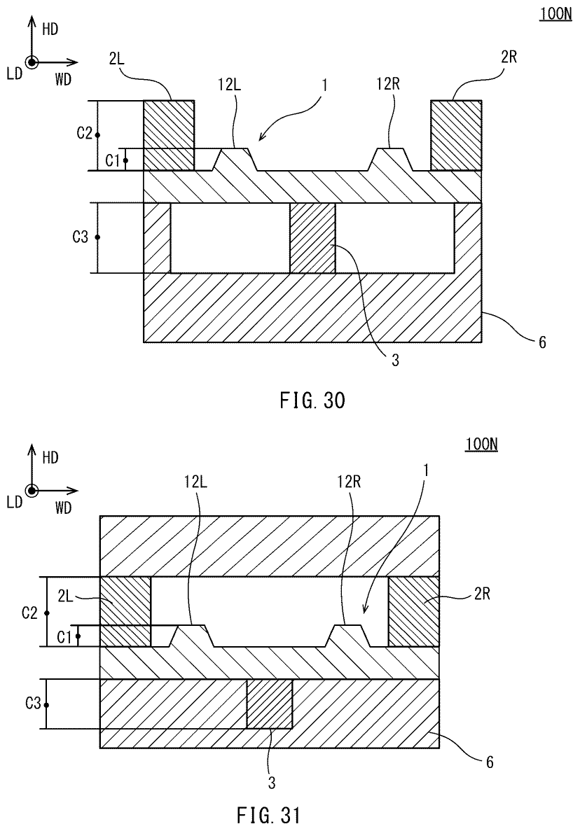

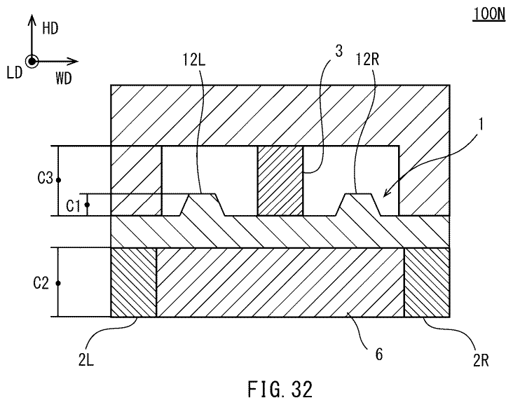

A configuration of an optical modulator 100N according to a fifteenth example embodiment of the present invention will be described with reference to FIGS. 29 to 32. These drawings are schematic diagrams illustrating the configuration of the optical modulator 100N according to the fifteenth example embodiment, and are cross-sectional views corresponding to FIG. 2A. In other words, FIGS. 20 to 32 are cross-sectional views when the optical modulator 100N is cut along a surface perpendicular or substantially perpendicular to the longitudinal direction LD at positions of the linear portions 122R and 122L of the branched optical waveguides 12R and 12L.

In each of the example embodiments, an example where the optical waveguide 1, the first electrodes 2R and 2L, and the second electrode 3 are arranged along or substantially along the height direction HD has been described. In the optical modulator 100N according to the present example embodiment, the arrangement of the optical waveguide 1, the first electrodes 2R and 2L, and the second electrode 3 is different from the other example embodiments.

In the optical modulator 100N illustrated in FIGS. 29 to 32, as in the other example embodiments, the first electrodes 2R and 2L are disposed on one side of the optical waveguide 1 in the height direction HD, and the second electrode 3 is disposed on another side of the optical waveguide 1 in the height direction HD. That is, with respect to the center C1 of the optical waveguide 1 in the height direction HD, the center C2 of the first electrodes 2R and 2L is disposed on one side, and the center C3 of the second electrode 3 is disposed on another side. In addition, the optical waveguide 1 is disposed between the first electrodes 2R and 2L and the second electrode 3 in the width direction WD. For example, the first electrodes 2R and 2L are disposed outside the optical waveguide 1 in the width direction WD, and the second electrode 3 is disposed inside the optical waveguide 1 in the width direction WD. Even in this case, when the optical modulator 100N is divided into one side and another side in the height direction HD from the lower surface of the optical modulator 100N, the first electrodes 2R and 2L are disposed on the one side, and the second electrode 3 is disposed on the other side as in the other example embodiments.

Although not illustrated, the optical modulator 100N illustrated in FIGS. 29 to 32 can include wiring electrodes having the same or substantially the same configuration as that according to any one of the other example embodiments.

Although the example embodiments according to the present disclosure have been described above, the present disclosure is not limited to the above-described example embodiments, and various changes can be made without departing from the spirit of the present disclosure.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical modulator comprising:
an optical waveguide with an electro-optic effect;
a first electrode on one side of the optical waveguide in a height direction of the optical modulator and extending along a portion of the optical waveguide;
a second electrode on another side of the optical waveguide in the height direction, to generate a potential difference between the second electrode and the first electrode, and to apply an electric field to the optical waveguide together with the first electrode; and
a first wiring electrode on a side of the first electrode opposite to the optical waveguide in the height direction and electrically connected to the first electrode; wherein
the first wiring electrode includes a wiring portion extending from an end portion in an extension direction of the first electrode when viewed along the height direction.

2. The optical modulator according to claim 1, wherein the first electrode is located in a cavity in the optical modulator.

3. The optical modulator according to claim 2, wherein
the first wiring electrode is located in the cavity and supported by a side wall defining the cavity.

4. The optical modulator according to claim 1, wherein
the first wiring electrode is spaced away from the first electrode in the height direction and includes a main body portion including a portion defining the wiring portion and a connection portion connecting the main body portion and the first electrode; and
the connection portion is inclined with respect to the height direction when viewed in a cross-section perpendicular or substantially perpendicular to the extension direction of the first electrode.

5. The optical modulator according to claim 1, wherein
the first wiring electrode is spaced away from the first electrode in the height direction and includes a main body portion including a portion defining the wiring portion and a connection portion connecting the main body portion and the first electrode;
the connection portion includes a surface that is continuous to the end portion in the extension direction of the first electrode; and
the surface is inclined with respect to the height direction such that a main body portion side with respect to a first electrode side is spaced away from the first electrode in the extension direction when viewed along a width direction of the optical modulator.

6. The optical modulator according to claim 2, wherein at least a portion of the first wiring electrode is self-supporting and located in the cavity.

7. The optical modulator according to claim 1, further comprising a through-electrode connected to the wiring portion of the first wiring electrode and extending from a first electrode side toward a second electrode side.

8. The optical modulator according to claim 7, wherein the through-electrode is inclined with respect to the height direction.

9. The optical modulator according to claim 1, wherein a thickness of the first electrode is greater than a thickness of the first wiring electrode.

10. The optical modulator according to claim 1, wherein
the first electrode and the first wiring electrode are coupled; and
a void is provided at an interface between the first electrode and the first wiring electrode.

11. The optical modulator according to claim 1, wherein
the first electrode and the first wiring electrode are coupled; and
oxygen is provided at an interface between the first electrode and the first wiring electrode.

12. The optical modulator according to claim 1, wherein
the first electrode and the first wiring electrode are coupled; and
a eutectic is provided between the first electrode and the first wiring electrode.

13. The optical modulator according to claim 1, wherein
the first electrode and the first wiring electrode are coupled; and
a resin is provided at an interface between the first electrode and the first wiring electrode.

14. The optical modulator according to claim 1, wherein, in a width direction of the optical modulator, a dimension of the first electrode is greater than a dimension of the optical waveguide.

15. The optical modulator according to claim 1, further comprising a low dielectric constant layer provided at at least one of a position between the optical waveguide and the first electrode and a position between the optical waveguide and the second electrode and having a refractive index lower than a refractive index of the optical waveguide.

16. The optical modulator according to claim 15, wherein
the low dielectric constant layer extends from the optical waveguide to the first electrode and from the optical waveguide to the first wiring electrode in the height direction; and
a dimension in the height direction of the low dielectric constant layer from the optical waveguide to the first wiring electrode is greater than a dimension in the height direction of the low dielectric constant layer from the optical waveguide to the first electrode.

17. The optical modulator according to claim 1, further comprising a support substrate on the side of the first electrode opposite to the optical waveguide and made of a low dielectric constant material having a refractive index lower than a refractive index of the optical waveguide.

18. The optical modulator according to claim 1, further comprising a second wiring electrode on a side of the second electrode opposite to the optical waveguide in the height direction and is electrically connected to the second electrode.

19. The optical modulator according to claim 18, further comprising a through-electrode connected to the second wiring electrode and extending from a second electrode side toward a first electrode side.

20. The optical modulator according to claim 18, wherein a thickness of the second electrode is greater than a thickness of the second wiring electrode.

21. The optical modulator according to claim 18, further comprising:
a first low dielectric constant layer extending from the optical waveguide to the first electrode and from the optical waveguide to the first wiring electrode in the height direction and having a refractive index lower than a refractive index of the optical waveguide; and
a second low dielectric constant layer extending from the optical waveguide to the second electrode and from the optical waveguide to the second wiring electrode in the height direction and having a refractive index lower than the refractive index of the optical waveguide; wherein
a dimension in the height direction of the first low dielectric constant layer from the optical waveguide to the first wiring electrode is greater than a dimension in the height direction of the first low dielectric constant layer from the optical waveguide to the first electrode; and
a dimension in the height direction of the second low dielectric constant layer from the optical waveguide to the second wiring electrode is greater than a dimension in the height direction of the second low dielectric constant layer from the optical waveguide to the second electrode.
